(19) United States
(12) Patent Application Publication
(10) Pub. No.: US 2024/0116007 A1
(43) Pub. Date: Apr. 11, 2024

(54) Hollow Fiber Membrane Supported Metal Organic Framework (MOF) Based Device

(71) Applicant: New Jersey Institute of Technology, Newark, NJ (US)

(72) Inventors: Kamalesh Sirkar, Bridgewater, NJ (US); Yufeng Song, Newark, NJ (US)

(73) Assignee: New Jersey Institude of Technology, Newark, NJ (US)

(21) Appl. No.: 18/377,482

(22) Filed: Oct. 6, 2023

Related U.S. Application Data
(60) Provisional application No. 63/413,813, filed on Oct. 6, 2022.

(51) Int. Cl. B01D 69/14; B01D 15/10; B01D 53/04; B01D 53/22; B01D 63/04; B01D 69/02; B01D 69/08; B01D 71/02

(52) U.S. Cl. CPC B01D 69/147; B01D 15/10; B01D 53/04; B01D 53/229; B01D 63/04; B01D 69/02; B01D 69/08; B01D 71/028; B01D 2253/204; B01D 2325/12

(57) ABSTRACT

A module for gas and/or vapor removal from a fluid stream is provided. The module includes at least one hollow fiber membrane including a first end and an opposing second end. The hollow fiber membrane includes a fiber wall defining an interior bore extending from the first end to the opposing second end and defining a passage for fluid flow through the hollow fiber membrane. The module includes a bed of metal organic framework (MOF) integrated into membrane pores of the fiber wall of the at least one hollow fiber membrane, into the hollow fiber membrane bore, and/or outside of the at least one hollow fiber membrane in an extracapillary space.

### CROSS-REFERENCE TO RELATED APPLICATIONS

This application claims the benefit of a co-pending, commonly assigned U.S. Provisional Patent Application No. 63/413,813, which was filed on Oct. 6, 2022. The entire content of the foregoing provisional application is incorporated herein by reference.

### STATEMENT OF GOVERNMENT SUPPORT

This invention was made with government support under Agreement No. HDTRA 1-16-1-0028 awarded by the Defense Threat Reduction Agency (DTRA), and Agreement Nos. 1034710 and 1822130 awarded by the National Science Foundation (NSF). The government has certain rights in the invention.

### FIELD OF THE DISCLOSURE

The present disclosure relates to a device for gas and vapor adsorption and, in particular, to gas and vapor adsorption with a device including hollow fiber membrane supported metal-organic framework (MOF) crystals. The present disclosure also relates to adsorption from a liquid solution using the same or substantially similar device.

### BACKGROUND

For adsorption-based separations, membrane separations, gas storage applications, catalytic degradations/reactions, barriers for ions in solution, barriers or masks for toxic gases and vapors, metal-organic framework (MOF) materials are of great interest. (See, e.g., Lu, X., et al., Water and Metal—organic frameworks: From interaction toward utilization. Chemical Reviews, 120, 8303-8377 (2020); Qian Q., et al., MOF-based membranes for gas separations. Chemical Reviews, 120, 16, 8161-8266 (2020); Li, X., et al., Metal-organic frameworks based membranes for liquid separation. Chem. Soc. Rev., 46, 7124 (2017); Li, J., et al., Metal-organic framework-based materials: superior adsorbents for the capture of toxic and radioactive metal ions. Chem. Soc. Rev., 2018, DOI: 10.1039/c7cs00543a; Chen, L., et al., Metal-organic framework composites for catalysis. Matter 1, 57-89, July 10 (2019); Lin, Y. S., Metal organic framework membranes for separation applications. Curr. Opin. Chem. Eng., 8, 21-28 (2015); Sorribas, S., et al., High flux thin film nanocomposite membranes based on metal-organic frameworks for organic solvent nanofiltration. J. Am. Chem. Soc., 135(40), 15201-15208 (2013); Kadhom, M., et al., Thin film nanocomposite membrane filled with metal-organic frameworks UiO-66 and MIL-125 nanoparticles for water desalination. Membranes, 7(2), 31 (2017); Zhao, Z., et al., Gas separation properties of metal organic framework (MOF-5) membranes. Ind. Eng. Chem. Res., 52(3), 1102-1108 (2012); Lin, J. Y., Molecular sieves for gas separation. Science, 353(6295), 121-122 (2016); Eum, K., et al., ZIF-8 Membranes via interfacial microfluidic processing in polymeric hollow fibers: Efficient propylene separation at elevated pressures. ACS Appl. Mater. Interfaces, 8 (38), 25337-25342 (2016); Hou, J., et al., Solvent-free route for metal-organic framework membranes growth aiming for efficient gas separation. AIChE J., 65(2), 712-722 (2019); Peterson, G. W., et al., Flexible SIS/HKUST-1 mixed matrix composites as protective barriers against chemical warfare agent simulants. ACS Appl. Mater. Interfaces, 10, 43080-43087 (2018); Qian Q., et al., Low-temperature H₂S/CO₂/CH₄ separation in mixed-matrix membranes containing MFU-4, Chem. Mater., 33, 17, 6825-683 (2021)). Selective adsorption/desorption of gases and vapors from gaseous streams/air is practiced extensively in large-scale industrial applications, as well as for cleaning up air streams having toxic gases and vapors. Novel sorbent materials, such as MOFs, material structures, and sorption methods, continue to be developed for such applications, as well as for protection against exposures to toxic gases and vapors encountered during industrial accidents. (See, e.g., Approval of Respiratory Protective Devices. Code of Federal Regulations, Part 84, Title 42, (1995)). The latter can include, e.g., ammonia, chlorine, sulfur dioxide, hydrogen sulfide, hydrogen cyanide, cyanogen chloride etc. (See, e.g., Peterson, G. W. et al., Engineering UiO-66-NH₂ for toxic gas removal. Ind. Eng. Chem. Res., 53(2), 701-707 (2014)). One MOF used in the industry is UiO-66-NH₂.

MOF crystals are intrinsically fragile. Therefore, their applications generally use structures or configurations that overcome the fragility, and yet allow access to their high porosity for selective sorption/storage and metallic links for catalytic destruction/selective sorption activities. The structures used are generally unable to remove toxic gases and vapors completely on a steady-state basis, resulting in the need for time-dependent adsorption-based processes. One type of structure discussed herein is a MOF-containing structure/format that allows adsorption-based gas separation/toxic gas removal/barrier functions at various scales of operation. Removal of the toxic gas ammonia (NH₃) is used as an example.

Earlier studies focused on MOF sorption properties via, for example, packed beds of MOF (UiO-66-NH₂) in the form of 20×40 mesh size granules. (See, e.g., Peterson, G. W. et al., Engineering UiO-66-NH₂ for toxic gas removal. Ind. Eng. Chem. Res., 53(2), 701-707 (2014); Jasuja, H., et al., Evaluation of MOFs for air purification and air quality control applications: Ammonia removal from air. Chem. Eng. Sci., 124, 118-124 (2015); Glover, T. G., et al., MOF-74 building unit has a direct impact on toxic gas adsorption. Chem. Eng. Sci., 66(2), 163-170 (2011)). Other structures studied include MOF-functionalized nonwoven fiber mats enabled by atomic layer deposition (see, e.g., Zhao, J., et al., Highly adsorptive, MOF-functionalized nonwoven fiber mats for hazardous gas capture enabled by atomic layer deposition. Adv. Mater. Interfaces, 1400040 (2014); Lemaire, P. C., et al., Copper benzenetricarboxylate metal-organic framework nucleation mechanisms on metal oxide powders and thin films formed by atomic layer deposition. ACS Appl. Mater. Interfaces, 8, 9514-9522 (2016)); and ink of polyvinylidene fluoride (PVDF) containing dispersed micron-sized MOF particles forming a thin film for use in a membrane reactor. (See, e.g., Denny, Jr, M. S., et al., Multicomponent metal-organic framework membranes for advanced functional composites. Chem. Sci., 9, 8842 (2018)). Shaping of the MOF particles into an appropriate size is essential for use in various packed-bed applications. The size considered reasonable is generally a 10×20 mesh. The pulverulent tendency of MOFs has posed a major problem in terms of shaping needed to achieve the ultimate commercially usable form, such as, e.g., pellets, monoliths, granules or the like. (See, e.g., Valekar, A. H., et al., Shaping of porous metal-organic framework granules using mesoporous p-alumina as a binder. RSC Adv., 7, 55767 (2017)).

The NH₃-air purification performances of UiO-66-COOH in bead, tablet, and extrudate forms were previously compared to those of commercial carbon-based materials (type K adsorbents from 3M and Norit) and found to be superior, especially under dry conditions. (See, e.g., Khabzina, Y., et al., Synthesis and shaping scale-up study of functionalized UiO-66 MOF for ammonia air purification filters. Ind. Eng. Chem. Res., 57, 8200-8208 (2018)). It has been suggested that a mechanically weak pellet can be obtained by pressing a MOF powder into pellets; however, the mechanical stability of the pellet is increased enormously by a Matrimid membrane coating on the pellet without significantly affecting sorption capacity. (See, e.g., Hossain, M. I., et al., Membrane-coated UiO-66 MOF adsorbents. Ind. Eng. Chem. Res., 58, 1352-1362 (2019)).

As such, there is an unmet need in the industry to improve the gas and vapor separation and purification process using MOFs. This and other needs are met by the exemplary hollow fiber membrane supported MOF based device of the present disclosure.

### SUMMARY

In accordance with embodiments of the present disclosure, an exemplary hollow fiber membrane supported metal-organic framework (MOF) based device (e.g., a hollow fiber membrane with an integrated MOF) is provided. In some embodiments, a hollow fiber membrane can include a membrane and a packed bed of metal-organic framework directly integrated into the membrane. The synthesis of the bed of MOF can be integrated with a final use structure of a hollow fiber-based module where the MOFs are protected by the hollow fiber membrane module (HFMM) from their fragile and pulverulent characteristics. In some embodiments, the membrane can include nanocrystals or microcrystals in the membrane pores, nanocrystals or microcrystals in the hollow fiber bores, nanocrystals or microcrystals in the extra capillary space, combinations thereof, or the like. It should be understood that other suitable crystals sizes can be used for the exemplary device.

In some embodiments, an exemplary solvothermal synthesis method is provided. The method can include providing a hollow fiber membrane and synthesizing crystals of metal organic framework directly inside submicron pores of the hollow fiber membrane. In some embodiments, the crystals can be synthesized outside the pores of the hollow fiber membrane.

In some embodiments, an exemplary solvothermal synthesis method is provided. The method can include providing a hollow fiber membrane and synthesizing nanocrystals of metal-organic framework directly inside submicron pores of the hollow fiber membrane and in bores of the hollow fiber membrane. It should be understood that microcrystals or other suitable crystal sizes can be used either in the pores of the hollow fiber membrane and/or in bores of the hollow fiber membrane.

In some embodiments, an exemplary solvothermal synthesis method is provided. The method can include providing a hollow fiber membrane and synthesizing nanocrystals of metal-organic framework directly inside submicron pores of the hollow fiber membrane, in bores of the hollow fiber membrane, and in the extra-capillary space of the hollow fiber membranes. It should be understood that microcrystals or other suitable crystal sizes can be used in the pores of the hollow fiber membrane, in bores of the hollow fiber membrane, and/or in the extra-capillary space of the hollow fiber membranes.

A hollow fiber membrane-based strategy is provided. Hollow fiber membrane (HFM) modules are highly preferred for industrial separation processes due to the high surface area provided per unit device volume and their easy scalability among others. Disclosed herein is a solvothermal synthesis method, whereby nanocrystals of the MOF, UiO-66-NH₂, are synthesized directly inside the submicron pores of hydrophilic hollow fiber membranes of Nylon 6 as well as in the bores of the HFMs. Nanocrystals of around 100 nm populate the HFM pores. Cylindrical modules containing such HFMs and MOF nanocrystals and microcrystals in membrane pores, HFM bores, and the extra capillary space were studied for adsorption of ammonia from a dilute gas stream. High values of ammonia breakthrough time were achieved. The corresponding behaviors of three configurations of MOFs namely, MOF in membrane pores, MOF in membrane pores and the HFM bores, and MOF present in membrane pores, HFM bores and, in the extra capillary space were studied. The values of time/MOF weight achieved were very high. The MOFs synthesized have been characterized by Scanning electron microscopy (SEM), Fourier-transform infrared spectroscopy (FTIR), powder X-ray diffractometer (PXRD), Brunauer-Emmett-Teller (BET) adsorption isotherms, surface area, and pore size distribution. High performance of hollow fiber membrane supported MOF-based scalable devices for gas/vapor adsorption has been demonstrated.

In accordance with embodiments of the present disclosure, an exemplary module for gas and/or vapor removal from a fluid stream. The module includes at least one hollow fiber membrane including a first end and an opposing second end. The at least one hollow fiber membrane includes a fiber wall defining an interior bore extending from the first end to the opposing second end and defining a passage for fluid flow through the at least one hollow fiber membrane. The module includes a bed of metal-organic framework (MOF) integrated into membrane pores of the fiber wall of the at least one hollow fiber membrane.

The interior bore defines a hollow fiber bore. The at least one hollow fiber membrane can include multiple hollow fiber membranes each including the interior bore extending from the first end to the opposing second end of the module. In such embodiments, each of the interior bores defines the passage for fluid flow through the respective hollow fiber membranes. The module includes an extracapillary space between outer walls of the multiple hollow fiber membranes.

The fiber wall defines a porous structure including the membrane pores. In some embodiments, the bed of MOF includes microcrystals disposed in the extracapillary space. In some embodiments, the bed of MOF includes nanocrystals in the membrane pores of the fiber wall. In some embodiments, the bed of MOF includes nanocrystals in the membrane pores of the fiber wall and microcrystals in the interior bore. In some embodiments, the bed of MOF includes nanocrystals in the membrane pores, a first set of microcrystals in the interior bore, and second set of microcrystals in the extracapillary space.

In accordance with embodiments of the present disclosure, an exemplary system for gas and/or vapor removal from a fluid stream is provided. The system includes a module including at least one hollow fiber membrane. The hollow fiber membrane includes a first end and an opposing second end. The at least one hollow fiber membrane includes a fiber wall defining an interior bore extending from the first end to the opposing second end and defining a passage for fluid flow through the at least one hollow fiber membrane. The module includes a bed of metal-organic framework (MOF) integrated into membrane pores of the fiber wall of the at least one hollow fiber membrane. The system includes a first port assembly coupled to the first end of the at least one hollow fiber membrane. The system includes a second port assembly coupled to the opposing second end of the at least one hollow fiber membrane.

The first port assembly can include an inlet port oriented perpendicularly to a central longitudinal axis of the at least one hollow fiber membrane. The inlet port is configured to introduce the fluid stream into the interior bore of the at least one hollow fiber membrane through the membrane pores of the fiber wall. The first port assembly can include an end port oriented in-line with the central longitudinal axis of the at least one hollow fiber membrane. The end port is blocked to prevent passage of the fluid stream through the end port, or the end port is open to allow passage of the fluid stream through the end port.

The second port assembly includes an outlet port oriented in-line with a central longitudinal axis of the at least one hollow fiber membrane. The outlet port is configured for exit of the fluid stream from the interior bore of the at least one hollow fiber membrane. The second port assembly includes an end port oriented perpendicularly to the central longitudinal axis of the at least one hollow fiber membrane. The end port is blocked to prevent passage of the fluid stream through the end port, or the end port is open to allow passage of the fluid stream through the end port.

In accordance with embodiments of the present disclosure, an exemplary method for gas, vapor and/or liquid adsorption is provided. The method includes providing a module. The module includes at least one hollow fiber membrane including a first end and an opposing second end. The at least one hollow fiber membrane includes a fiber wall defining an interior bore extending from the first end to the opposing second end and defining a passage for fluid flow through the at least one hollow fiber membrane. The method includes synthesizing a first bed of metal-organic framework (MOF) directly inside membrane pores of the fiber wall of the at least one hollow fiber membrane.

The membrane pores include submicron pores and bores of the order of about 100-3000 micrometers, inclusive. The method includes synthesizing a second bed of metal organic framework (MOF) directly inside the membrane bores of the at least one hollow fiber membrane. The at least one hollow fiber membrane includes multiple hollow fiber membranes and the module includes an extracapillary space between outer walls of the multiple hollow membranes. The method includes synthesizing a third bed of metal organic framework (MOF) directly inside the extracapillary space. The first bed of MOF is integrated into the membrane pores.

Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the exemplary hollow fiber membrane supported MOF-based device and associated systems and methods, reference is made to the accompanying figures, wherein:

FIGS. 1A-D are diagrammatic views of an exemplary porous hollow fiber membrane-based packed bed of MOFs for removing ammonia from a gas stream in accordance with embodiments of the present disclosure, including an overall view of the porous hollow fiber membrane-based packed bed of MOFs (FIG. 1A), detailed views (FIG. 1B and FIG. 1C), and a cross-sectional view (FIG. 1D). MOFs are present as nanocrystals in submicron pores of a hollow fiber microcrystal (HFM) wall, microcrystals in a HFM bore, and microcrystals in the extra capillary space.

FIG. 2A is a scanning electron microscope (SEM) image of a cross section of one Nylon HFM, and FIG. 2B is an SEM image of a cross-section of three contiguous Nylon HFMs.

FIGS. 3A-B are SEM images of the cross-section of a part of the porous wall of MOF-filled Nylon hollow fiber membrane at varying magnifications: ×30,000 (FIG. 3A) and ×10,000 (FIG. 3B).

FIG. 4 is a Fourier transform infrared (FTIR) spectra of UiO-66-NH₂ MOF-filled Nylon hollow fiber membrane and virgin Nylon hollow fiber membrane.

FIGS. 5A-C illustrate graphs of ammonia breakthrough data with 100 ppmv (70.8 mg/m³) NH₃-containing gas stream flowing at 10 cm³/min at a RH of ˜50% through UiO-66-NH₂ MOF-loaded Nylon hollow fiber membrane module (MOF loaded in the HFM pores only) (FIG. 5A), breakthrough data normalized by weight of MOF-HFMs (FIG. 5B), and breakthrough data normalized by weight of MOF only (FIG. 5C). Dashed lines plot the data calculated based on the whole length (10.9 cm) of the HFMs, and solid lines plot the data calculated based on the active length (8.2 cm) of the HFMs.

FIGS. 6A-C show graphs of ammonia breakthrough data with 100 ppmv (70.8 mg/m³) NH₃-containing gas stream flowing at 10 cm³/min at a RH˜50% through regenerated MOF-loaded Nylon HFM module (MOF loaded in HFM pores only) (FIG. 6A), normalized by weight of MOF-HFMs (FIG. 6B), and normalized by weight of MOF (FIG. 6C). Dashed lines plot the data calculated based on total length (10.9 cm) of the HFMs, and solid lines plot the data based on active length (8.2 cm) of the HFMs.

FIGS. 7A-F show graphs of ammonia breakthrough test with 100 ppmv (70.8 mg/m³) NH₃-containing gas stream (RH˜50%) flowing at 10 cm³/min through MOF-loaded Nylon HFM-based module, with MOFs in HFM pores and bores (FIG. 7A), data replotted against time/weight of MOF crystals plus HFM (FIG. 7B) data replotted against time/weight of MOF crystals only (FIG. 7C) and results of NH₃ breakthrough test under the same respective conditions for MOF-loaded Nylon HFM-based module, with MOFs in HFM pores, HFM bores and the extra capillary space (FIG. 7D, FIG. 7E and FIG. 7F). Dashed lines plot the data calculated based on the whole length (10.9 cm) of the HFMs, and solid lines are based on the active length (8.2 cm) of the HFMs.

FIG. 8 is a graph of N₂ isotherm plots at 77K for virgin Nylon 6 hollow fiber membrane, Nylon 6 hollow fiber membrane with UiO-66-NH₂ MOF loading, and UiO-66-NH₂ MOF achieved during HF-MOF preparation.

FIGS. 9A and 9B are graphs of pore size distribution calculated from N₂ isotherm plots at 77 K for UiO-66-NH₂ MOFs in virgin Nylon HF membranes by DFT method illustrated in two different scales.

FIG. 10 is a graph of PXRD patterns of 20 from 2° to 60° of UiO-66-NH₂ MOF synthesized in Nylon 6 hollow fiber membrane, and PXRD patterns of virgin Nylon 6 hollow fiber membrane, MOF achieved during synthesis and SDS are also shown.

FIG. 11 is a filtration setup where methylene blue (MB) containing aqueous solution percolates through the MOF bed in pores of a flat membrane or a stack of two or three flat membranes.

FIG. 12 is a side view of an exemplary hollow fiber membrane module.

FIGS. 13A-B are graphs of ammonia breakthrough data with 100 ppmv (70.8 mg/m³) NH₃-containing gas stream flowing at 10 cm³/min at a RH˜50% through the 2nd time regenerated MOF-loaded Nylon HFM module (MOF loaded in HFM pores only) normalized by weight of MOF-HFMs (FIG. 13A), and normalized by weight of MOF (FIG. 13B).

FIG. 14 is a graph of ammonia sorption capacity calculation for UiO-66-NH₂ MOF nanocrystals in HFM pores only, which corresponds with data illustrated in FIG. 6C.

FIG. 15 is a diagrammatic view of the setup for packing MOF particles into the shell side of the MOF HFM modules.

FIGS. 16A-D show views of the setup for packing MOF particles into the shell side of the MOF HFM modules, including an overall view of the setup (FIG. 16A), a detailed view of the setup (FIG. 16B), a detailed view of a cotton sliver (FIG. 16C), and a detailed view of the ePTFE membrane (FIG. 16D).

FIGS. 17A-C are side (FIG. 17A), bottom (FIG. 17B), and top (FIG. 17C) views of the Type III MOF-HFM module.

FIG. 18 is a diagrammatic view of ammonia breakthrough testing for UiO-66-NH₂ MOF-loaded Nylon HFM-based modules.

FIG. 19 is a table of physical properties of hollow fiber membranes used during experimentation.

FIG. 20 is a table of details of hollow fiber membrane modules for experimentation.

FIG. 21 is a table of an ammonia breakthrough test of the regenerated UiO-66-NH₂ MOF-loaded Nylon HFM-based module.

FIG. 22 is a table of BET based surface area estimates.

FIG. 23 is a table of results of methylene blue adsorption by MOF in Nylon membrane pores.

### DETAILED DESCRIPTION

The present disclosure now will be described more fully hereinafter with reference to the accompanying drawings, in which illustrative embodiments of the invention are shown. In the drawings, the relative sizes of regions or features may be exaggerated for clarity. This present disclosure may, however, be embodied in many different forms and should not be construed as limited to the embodiments set forth herein; rather, these embodiments are provided so that this disclosure will be thorough and complete, and will fully convey the scope of the invention to those skilled in the art. Well-known functions or constructions may not be described in detail for brevity and/or clarity.

The terminology used herein is to describe particular embodiments only and is not intended to limit the scope of the invention. As used herein, the singular forms “a”, “an” and “the” are intended to include the plural forms as well, unless the context clearly indicates otherwise. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

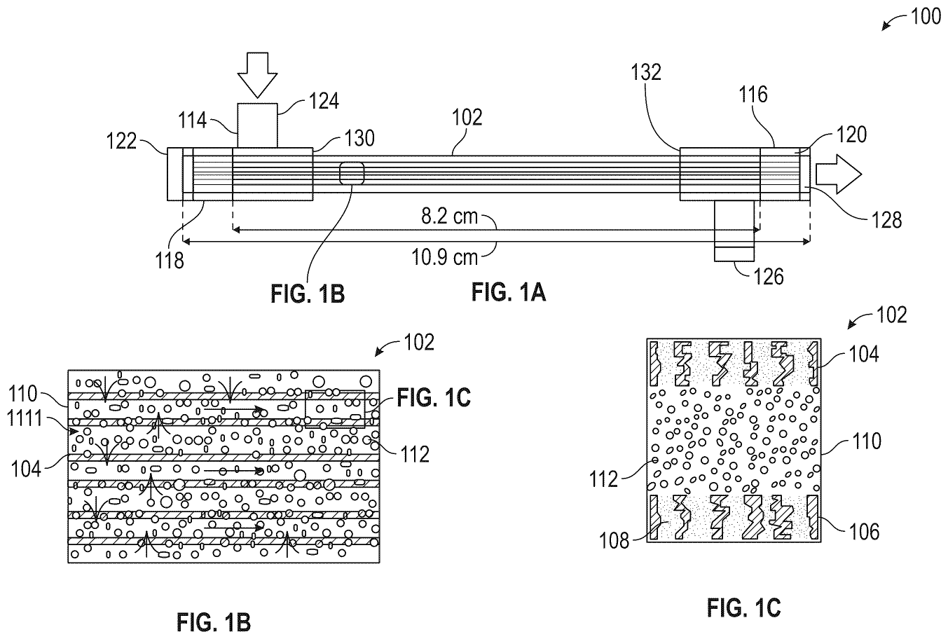

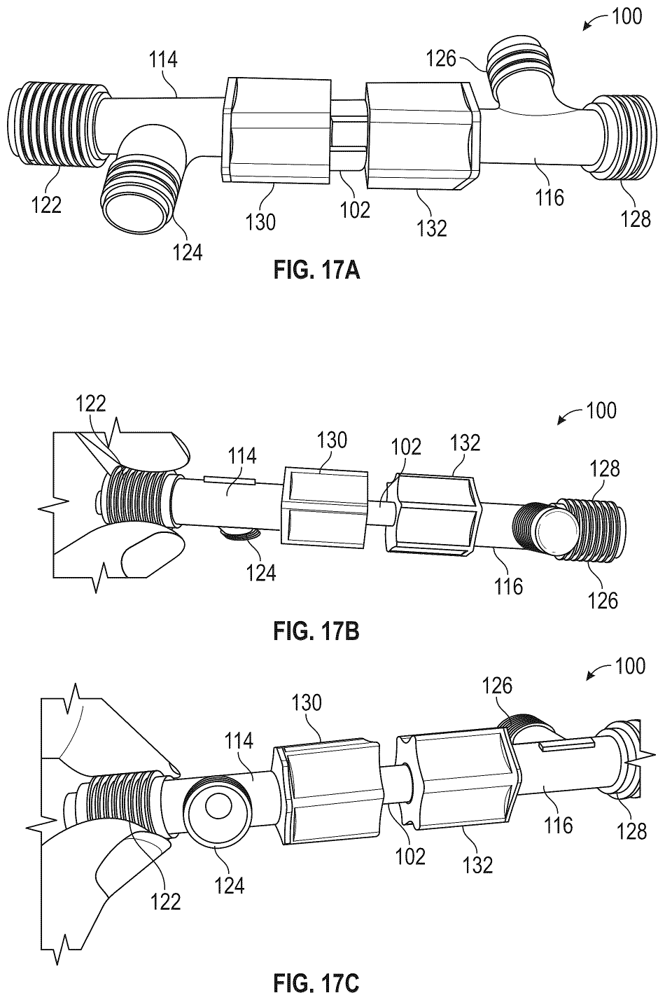

FIGS. 1A-D are diagrammatic views of an exemplary hollow fiber membrane supported metal organic framework based device 100 (hereinafter “device 100”). FIG. 12 (and FIGS. 17A-C) is an assembly of the device 100—as such, same reference numbers refer to same structures. The device 100 can be a porous hollow fiber membrane-based packed bed of MOFs for removing toxic gases and vapors, such as ammonia, from a gas stream. The device 100 can also be used for removing CO₂ from air or any other gaseous stream. In some embodiments, the device 100 can be used for removing oxygen from hydrogen streams generated by electrolysis of water. The device 100 includes a hollow fiber membrane module 102 having a MOF-hollow fiber structure (HFS). The module 102 can define a substantially cylindrical configuration with a hollow interior. The hollow interior of the module 102 includes fiber walls 104 that extend along the length of the module 102.

As illustrated in FIG. 1D, each of the fiber walls 104 can define a substantially cylindrical configuration with a hollow interior (e.g., fiber bores 110) (e.g., having a substantially circular cross-section). The module 102 includes multiple cylindrical fiber walls 104 extending parallel to each other along the length of the module 102. The fiber walls 104 generally extend in a direction parallel to a central longitudinal axis of the module 102 to allow for flow in a substantially parallel direction along the length of the module 102. In some embodiments, the fiber walls 104 define substantially equal diameters (both inner and outer diameters), and define substantially equal wall thicknesses. In some embodiments, the fiber walls 104 can have different inner/outer diameters and create multiple substantially parallel flow paths within the module 102 having differently sized flow paths. The fiber walls 104 are spaced from each other by a predetermined distance, with the space between the fiber walls 104 defining an extracapillary space 111. The fiber walls 104 themselves can have a hollow or porous structure that allows for membrane pores 106 of the fiber walls 104 to be filled with nanocrystals 108. Within the respective fiber walls 104, the module 102 includes hollow fiber bores 110 that include microcrystals 112. In some embodiments, the module 102 can include microcrystals 112 disposed in extra hollow fiber spaces between the hollow fibers of the fiber walls 104 (i.e., in the extracapillary space 111).

The device 100 includes a first or upstream port assembly 114 at one end of the module 102, and a second or downstream port assembly 116 at the opposing end of the module 104. The port assemblies 114, 116 allow testing of the module 102. Epoxy 118, 120 or any other adhesive can be used to couple the port assemblies 114, 116 to the respective ends of the module 102. The first port assembly 114 includes an end port 122 disposed in-line with the central longitudinal axis of the module 102. The end port 122 can be blocked from passage of fluids and/or gases. The first port assembly 114 includes an inlet port 124 oriented perpendicularly to the central longitudinal axis of the module 102, with the inlet port 124 in fluid communication with the hollow interior of the module 102 such that gas and/or fluid (NH₃, N₂, air, H₂, H₂O, or the like) can be introduced into the module 102 through the inlet port 124. The first port assembly 114 includes a connection port 130 aligned with the central longitudinal axis of the port 122 and the module 102, and is configured to receive an end of the module 102.

The second port assembly 116 includes a secondary port 126 (e.g., end port) oriented perpendicularly to the central longitudinal axis of the module 102. The secondary port 126 can be blocked from passage of fluids and/or gases. The second port assembly 116 includes an outlet port 128 disposed in-line with the central longitudinal axis of the module 102. The outlet port 128 is in fluid communication with the hollow fiber bores 110 such that gas and/or fluid (N₂, H₂O, or the like) can exit the module 102. In this arrangement, the gas mixture entering the shell side (namely the region of module 102 through inlet 124) has to pass through the porous wall 104 of the hollow fibers and contact nanocrystals 108 in membrane pores 106 along with microcrystals 112 in regions of the module 102, and then leave/exit the module 102 through the end of hollow fiber bores 110 and outlet port 128. The second port assembly 116 includes a connection port 132 aligned with the central longitudinal axis of the port 128 and the module 102, and is configured to receive an end of the module 102. In some embodiments, the distance within the module 102 along which the gas and/or fluid can travel (e.g., the distance between the inlet port 124 and the outlet port 128) can be about 8.2 cm. In some embodiments, the overall distance of the module 102 can be about 10.9 cm. In some embodiments, the overall distance of the module 102 can be as long as about 1500 cm.

The hollow fiber membrane module 102 can include a plurality of fibers, each fiber having the membrane walls 104, a membrane bore 110, membrane pores 106, and extracapillary space 111. As shown in FIGS. 1A-D, the MOFs are present as nanocrystals 108 in submicron pores 106 of a hollow fiber membrane wall 104 and as microcrystals 112 in the hollow fiber membrane bore 110 (as well as in the extracapillary space 111, in some embodiments). Any suitable crystal size can be used for the pores 106, the bore 110, and the extracapillary space 111. In some embodiments, the size of the crystals in the pores 106 is smaller than the size of the membrane pores by an order of magnitude or more. In some embodiments, the size of the crystals in the membrane bores 110 is smaller than the dimension of the hollow fiber bore. In some embodiments, the size of the crystals in the extracapillary space 111 is dimensioned smaller than the radial gap between the contiguous hollow fiber walls 104 (preferably of the same order of magnitude). In some embodiments, the MOFs can be, e.g., UiO-66-NH₂.

The porous hollow fiber membrane (HFM)-based cylindrical modules 102 include HFMs that are relatively close to one another. In particular, in industrial membrane gas separation or purification, HFMs are typically highly packed in a module. In contrast, the module 102 includes HFMs that are close to one another. For example, the fractional void volume occupied by hollow fibers in the module 102 can be as high as about 0.5 in highly packed systems. Therefore, some MOF microcrystals 112 are located in the extra fiber space (i.e., the extracapillary space 111), and some microcrystals 112 are located in the bore 110 of the HFMs at any location, as shown in FIGS. 1B-D In some embodiments, the module 102 can have a consistent distribution of microcrystals 112 along the length of the module 102. In some embodiments, the distribution of crystals along the length of the module 102 can be consistent for each type of crystal used. In some embodiments, the module 102 can include microcrystals 112 of a MOF different from the MOF used to manufacture the nanocrystals 108 in the membrane pores 106. In some embodiments, two different MOFs can be used—one in the hollow fiber bore and one in the extracapillary space 111, with both MOFs different from the MOF type used in the membrane pores 106. The microcrystals 112 in the HFM bore 110 and the extracapillary space 111 are supported from the HFM wall 104 by friction and are not subjected to the load of MOF microcrystals 112 present above in a vertically oriented module 102. This issue does not arise if the HFM module 102 is used in a horizontal orientation.

In some embodiments, hollow fiber membranes are used during MOF synthesis such that the pores can be loaded with the MOF synthesis solution and end up with nanocrystals in the submicron size HFM pores. The bores of HFMs are also populated with microcrystals and nanocrystals during MOF synthesis. In some embodiments, the porous HFMs can be, e.g., hydrophilic Nylon 6, 6. However, HFMs of other polymers and/or wetting properties can be used as well.

Because a dimethylformamide (DMF)-methanol based solution was used for MOF synthesis in one embodiment, Nylon membrane pores were spontaneously wetted by the solution to be used for solvothermal synthesis of MOF. This is unlike the use of flat expanded polytetrafluoroethylene (ePTFE) membranes used earlier, where an extensive and multistep solvent exchange process had to be undertaken to get mixed DMF and methanol solution containing the reactants inside the membrane pores. (See, e.g., Song, Y., et al., Membrane-supported metal organic framework based nanopacked bed for protection against toxic vapors. Separation and Purification Technology, 251, 117406 (2020)). The solvent exchange process started with pure methanol as solvent (which wets PTFE pores easily), which ultimately ended with 80% DMF-20% methanol solution of the reactants in the pores of a flat ePTFE membrane, which is not spontaneously wetted by the polar aprotic solvent DMF. The present Nylon membrane-based process is simpler than the previous processes, where vacuum facilitated introduction of the DMF-methanol solution was undertaken with a flat ePTFE membrane. (See, e.g., Song, Y., et al., Graphene oxide and metal organic framework based breathable barrier membrane for toxic vapors, ACS Appl. Mater. Interfaces, 14, 31321-31331 (2022)). The current approach of using hydrophilic porous Nylon HFM can also be used with hydrothermal MOF synthesis. (See, e.g., Khabzina, Y., et al., Synthesis and shaping scale-up study of functionalized UiO-66 MOF for ammonia air purification filters. Ind. Eng. Chem. Res., 57, 8200-8208 (2018)). The present disclosure is distinct from that used to make highly porous MOF-containing flat membranes for liquid separations by a thermally induced phase separation-hot pressing strategy using MOFs, polyethylene and paraffin, which is extracted out later. (See, e.g., Wang, H., et al., Membrane adsorbers with ultrahigh metal-organic framework loading for high flux separations. Nature Communications, 10:4204 (2019)). The exemplary process described herein can use existing porous membranes in hollow fiber or flat forms. The process can include synthesizing MOF nanocrystals in hollow fiber membrane pores and hollow fiber bores. In other processes, the porous membrane is synthesized from a polymer melt-based TIPS process into which preformed MOFs are dispersed, and only flat membrane forms were synthesized. (See, e.g., Wang, H., et al., Membrane adsorbers with ultrahigh metal-organic framework loading for high flux separations. Nature Communications, 10:4204 (2019)). In contrast, the exemplary process can use a variety of already existing membranes, including those in hollow fiber forms.

The module 102 shown in FIGS. 1A-C and FIG. 12 was used during experimentation to study breakthrough of NH₃ from a N₂ stream under the following three module configurations: Type I—HFMs including nanocrystals 108 in the membrane pores 106 only; Type II—HFMs having nanocrystals 108 in the membrane pores 106 and microcrystals 112 in the HFM bore 110; and Type III—HFMs having nanocrystals 108 in the membrane pores 106 and microcrystals 112 in the HFM bore 110 and in the shell-side inter-fiber space. The MOFs in various locations were characterized. Successful regeneration of the MOF adsorbents was investigated. The hollow fiber membrane-based device 100 having MOF nanocrystals and microcrystals was investigated for its capacity to remove ammonia from a gas stream. The results for different situations are summarized below. The results include hollow fiber membrane characterization, results from nanocrystal synthesis in HFM pores, characterization of MOFs, characterization of ammonia adsorption behavior, characterization of ammonia adsorption behavior after regeneration of the adsorbents after one use, and behavior of different configurations of MOFs and HFMs.

Results

Porous Nylon HFMs and MOF Nanocrystals in Submicrometer HFM Pores

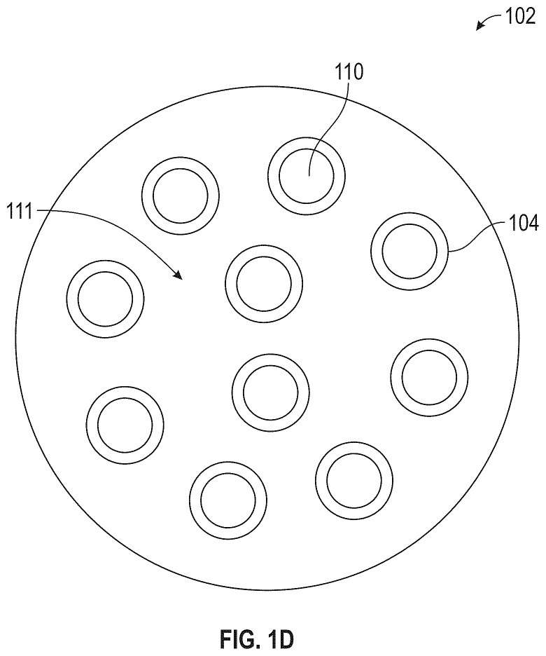

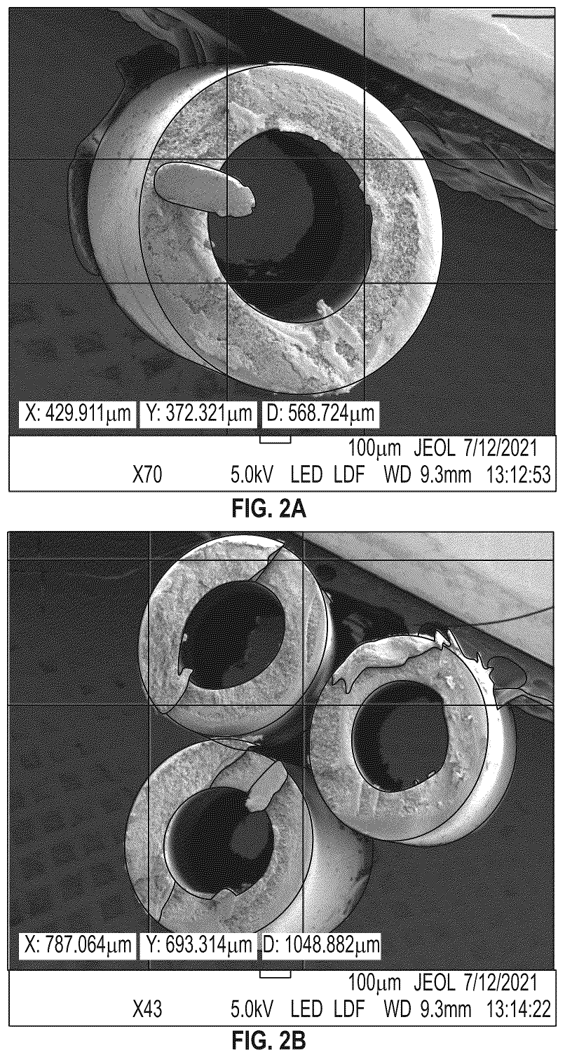

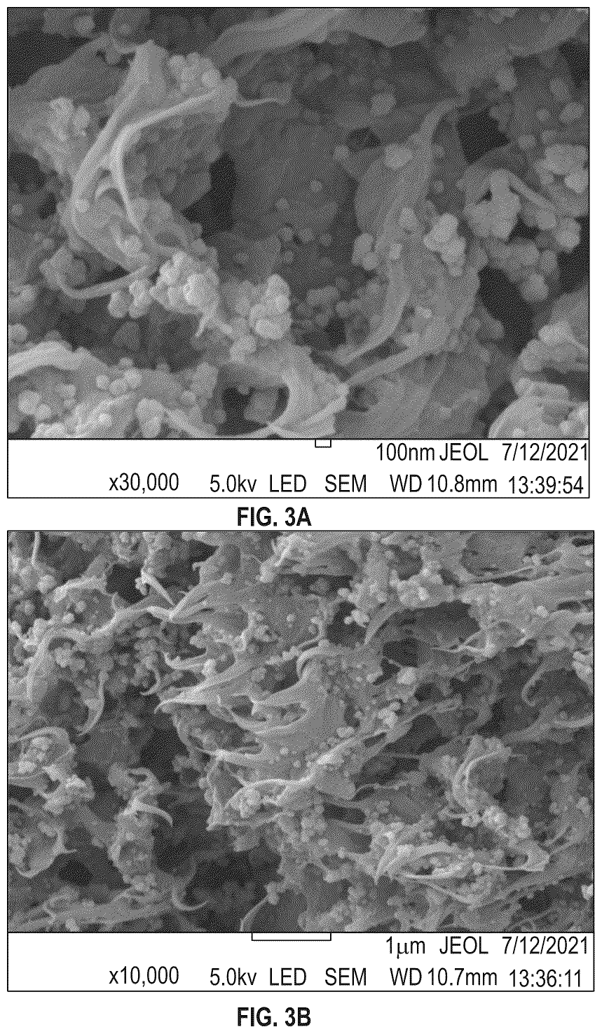

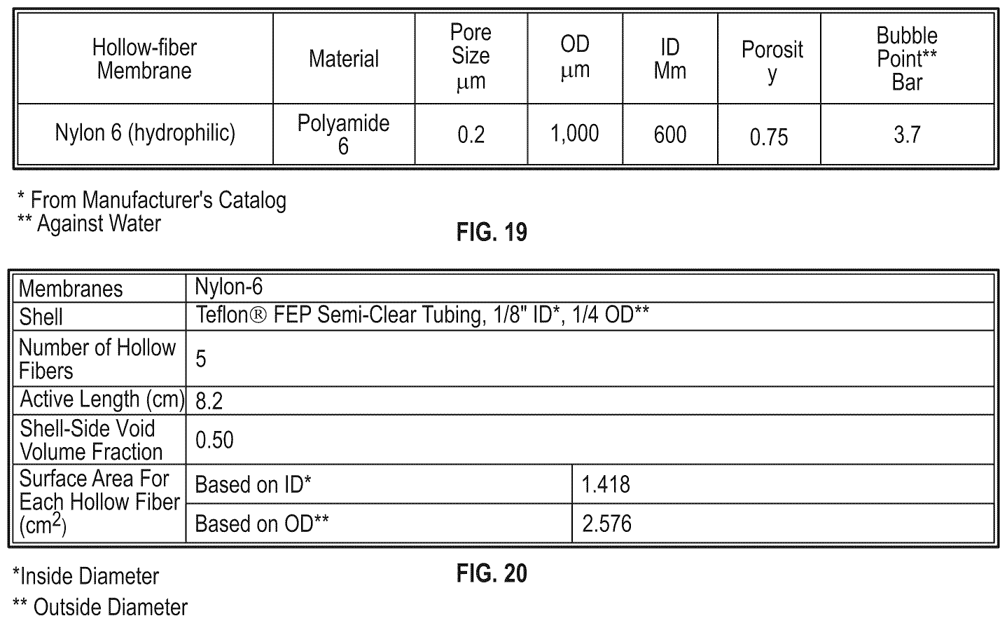

Modules of HFMs can provide high surface area/device volume going up to 35-40 cm²/cm³. Correspondingly, these structures can also create a large reservoir of adsorbent surface area per unit device volume. FIGS. 2A and 2B show the scanning electron micrograph (SEM) based cut sections of a single HFM (FIG. 2A) and multiple Nylon HFMs (FIG. 2B) with each HFM outside diameter (OD)/inside diameter (ID) being 1000/600 μm (see table of FIG. 19). FIG. 3A shows a 30,000× magnification-based SEM of the cross-sectional details of any location in the porous wall of a single Nylon HFM filled with nanocrystals of the MOF synthesized in situ. Virtually all MOF crystals dispersed throughout the porous wall are around 100 nm. It should be understood that the MOF crystals can be of any suitable size. FIG. 3B is taken at a lower magnification (10,000×) and reinforces the conclusion made regarding FIG. 3A. It is also clear that there is still a large void volume available inside the porous HFM wall cross section such that there is unlikely to be significant gas flow pressure drop. Given such an excess of unoccupied space in the pores in the membrane wall, another round of solvothermal/hydrothermal synthesis of MOFs can be optionally undertaken to increase the loading of MOF nanocrystals in the membrane pores. (See, e.g., Song, Y., et al., Membrane-supported metal organic framework based nanopacked bed for protection against toxic vapors. Separation and Purification Technology, 251, 117406 (2020); Song, Y., et al., Graphene oxide and metal organic framework based breathable barrier membrane for toxic vapors, ACS Appl. Mater. Interfaces, 14, 31321-31331 (2022)). The hollow fiber membrane wall porosity is 0.75 in this embodiment (see table of FIG. 19).

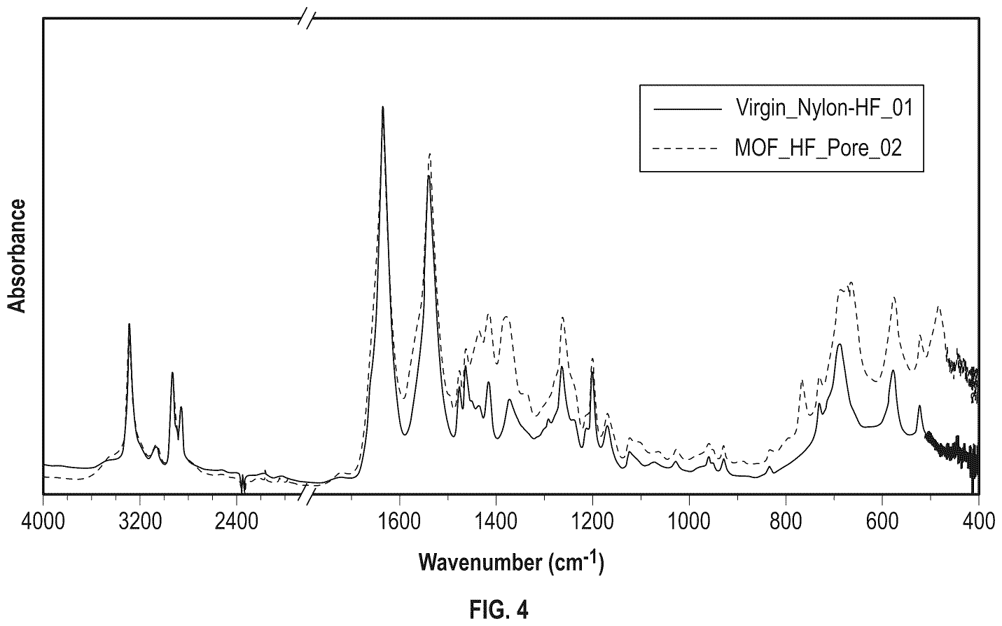

FIG. 4 illustrates the FTIR spectra of the virgin Nylon HFM, as well as those of the UiO-66-NH₂ MOF-filled Nylon HFM. The characteristic peaks of the MOF at 659 cm⁻¹ and 477 cm⁻¹ are associated with the Zr—(OC) bond. Two bands appearing between 1566 cm 1 and 1400 cm⁻¹ correspond to the antisymmetric and symmetrical stretching and bending vibration of the structure. These spectra demonstrate that this MOF can be successfully synthesized using equimolar amounts of ZrCl₄ and H₂BDC-NH₂ in 80% DMF-20% methanol in the HFM pores.

Ammonia Adsorption Behavior of the HFM-Based Packed Bed

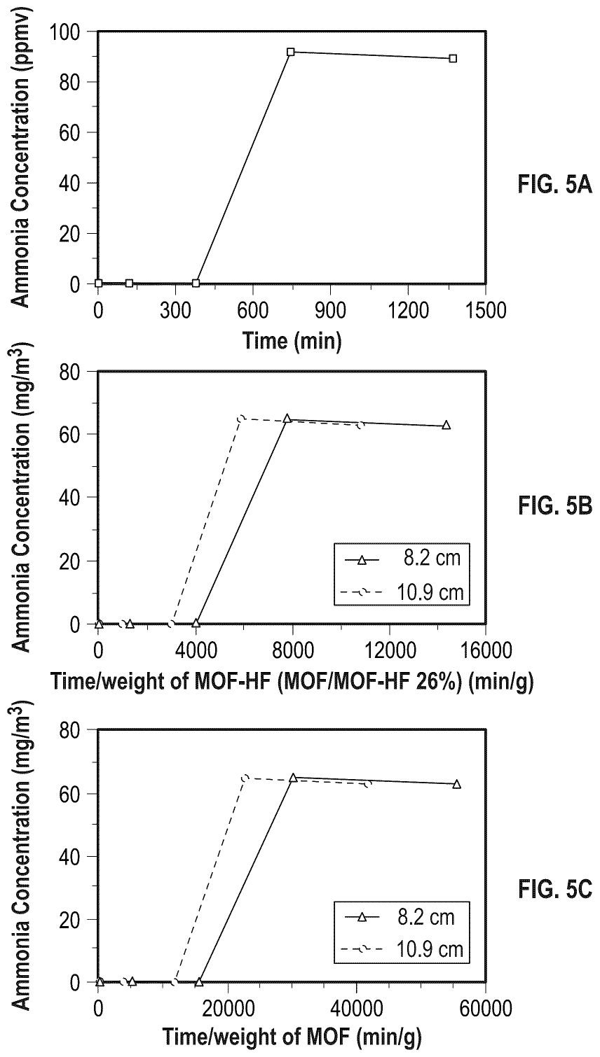

Ammonia adsorption properties of the MOF nanocrystal loaded HFM pores are shown in FIGS. 5A and 5B. The ammonia adsorption properties were investigated by introducing a 100 ppmv (70.8 mg/m³) NH₃-containing gas stream (relative humidity (RH), 50%) flowing at 10 cm³/min into the shell-side of a HFM module, e.g., via port assembly 114 (five HFMs in the module; total outer membrane surface area of 12.88 cm² (see table of FIG. 20 with module details)). The permeated gas was collected coming through the open tube side of the HFMs, e.g., via port assembly 116, through the tube-sheet. The open area of the flat MOF-filled ePTFE membrane film surface area was much smaller about 2.84 cm² (see, e.g., Song, Y., et al., Membrane-supported metal organic framework based nanopacked bed for protection against toxic vapors. Separation and Purification Technology, 251, 117406 (2020))). FIG. 5A results are illustrated in FIG. 5B via ammonia breakthrough behavior plotted against the x-axis describing the time/adsorbent weight where the weight includes MOF adsorbent plus HFMs. These results show that the breakthrough time is 50-100% larger than that in an earlier work with flat membranes: (See, e.g., Song, Y., et al., Membrane-supported metal organic framework based nanopacked bed for protection against toxic vapors. Separation and Purification Technology, 251, 117406 (2020)). In particular, the difference is about 3000-4000 min/g vs. 2000 min/g. Similarly, the value is about 2100 min/g for the MOF MIL-100(Fe). (See, e.g., Valekar, A. H., et al., Shaping of porous metal-organic framework granules using mesoporous p-alumina as a binder. RSC Adv., 7, 55767 (2017)).

If the weight of the HFMs was eliminated for a more accurate estimate, this would result in a high value of 12000 to 15000 min/g of MOF as shown in FIG. 5C, depending on whether the whole length of the HFMs or the active length of the HFMs is taken, since the section of the hollow fiber membranes potted in the epoxy tube-sheets near the gas entrance to the module is generally ineffective. In longer modules, the effect of the inactive length is reduced (e.g., based on proportional size/length). Regeneration of the thin packed bed of nanocrystals of MOFs was implemented.

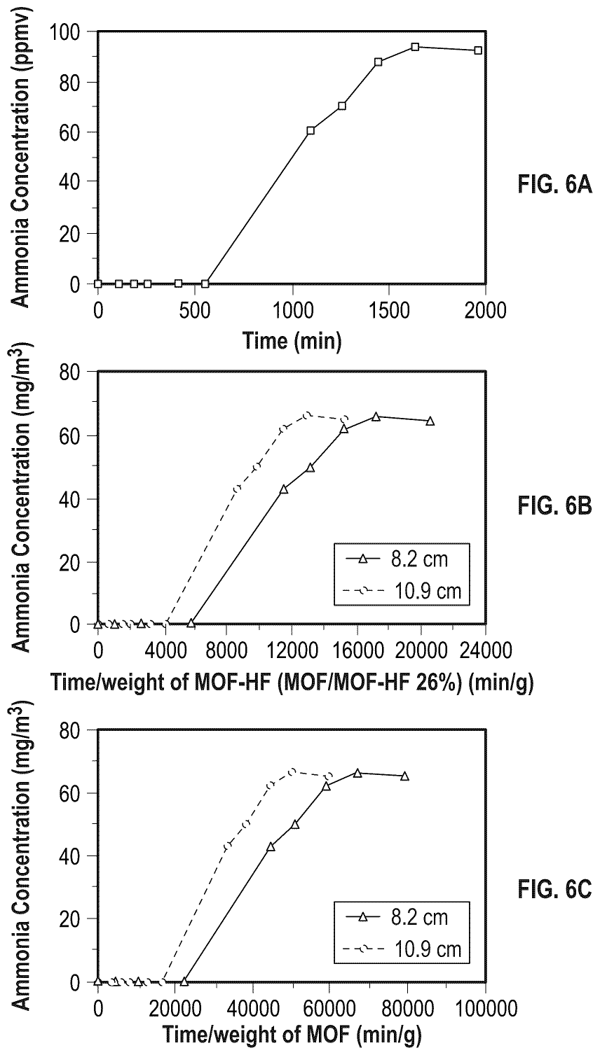

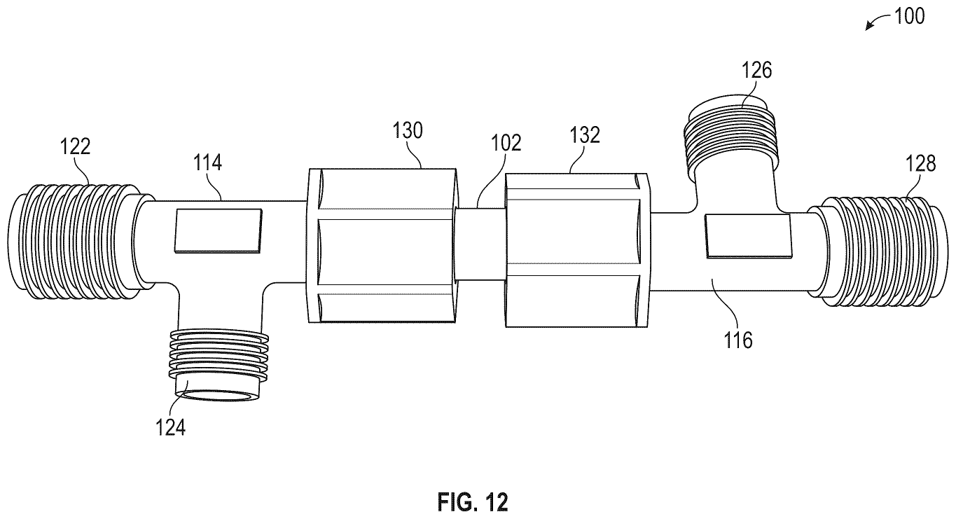

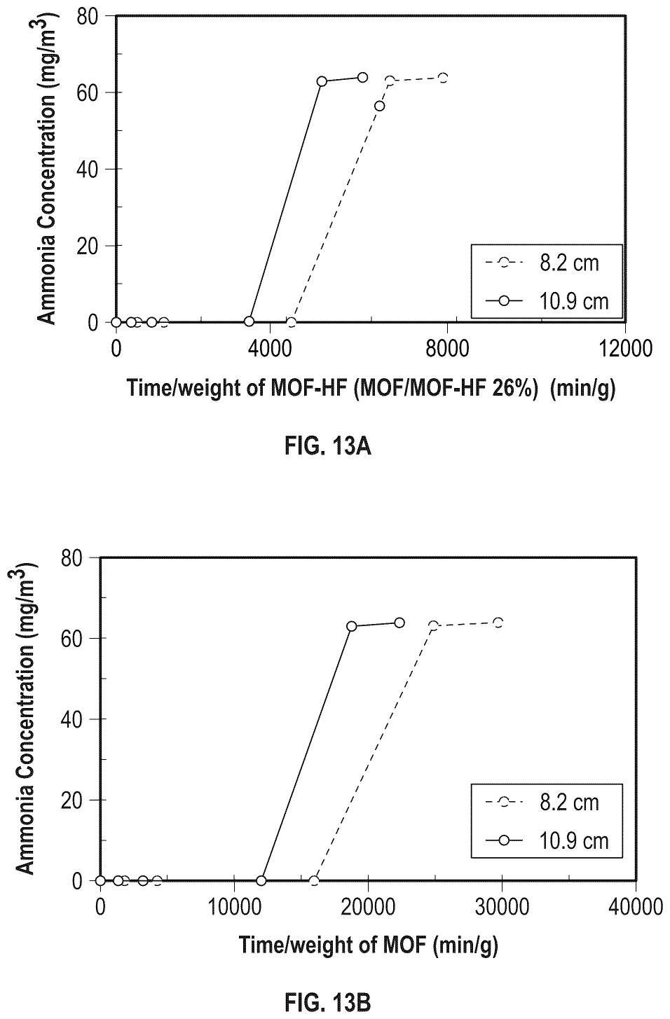

FIGS. 6A-C show the performance of the regenerated bed. The performance is somewhat better than the first sorption run (of FIGS. 5A-C), indicating that solvent removal from the bed was incomplete before conducting runs with the virgin adsorbent. The performance of the bed after the second regeneration is shown in FIGS. 13A-B. The performances are similar to what was observed in FIGS. 6A-C.

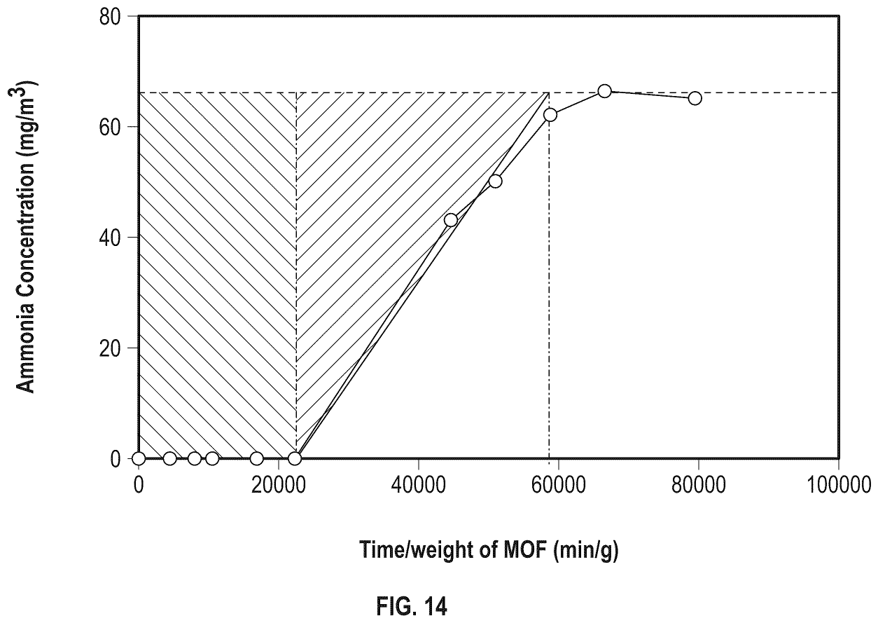

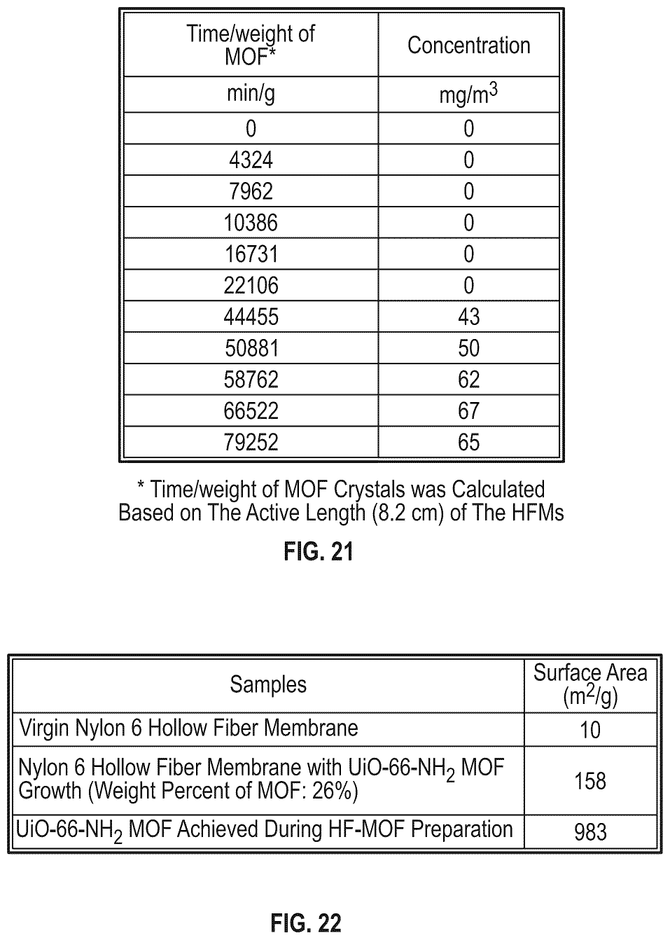

It is useful to develop an estimate of the sorption capacity of the nanocrystals of UiO-66-NH₂ MOF existing in the submicron pores of the HFM for ammonia. Using a conventional packed bed of MOF particles in a 4 mm i.d. glass fritted tube, it was reported that the NH₃ sorption capacity was 3.56 and 3.01 mmol/g for dry and wet gases, respectively, for feed concentration levels of 1000 or 2000 mg/m³. (See, e.g., Jasuja, H., et al., Evaluation of MOFs for air purification and air quality control applications: Ammonia removal from air. Chem. Eng. Sci., 124, 118-124 (2015)). During experimentation, the ammonia sorption was calculated by integrating the breakthrough curve for the UiO-66-NH₂ MOF-loaded Nylon HFM-based module shown in FIG. 14 and the associated information under the table of FIG. 21 (as well as the discussed below with respect to the table of FIG. 21). Based on the results, the capacity up to the point when ammonia first appears in the outlet at a very low concentration (e.g., as low as 1-2 ppmv, as measured) is 0.86 mmol/g for the feed gas having 50% RH. When the complete feed breakthrough concentration is considered, the corresponding sorption capacity is 1.58 mmol/g. The pore length/wall thickness of the MOF-HFM is only 200 μm, which is 20 times less than the packing thickness (4 mm) used in the ammonia breakthrough testing. (See, e.g., Jasuja, H., et al., Evaluation of MOFs for air purification and air quality control applications: Ammonia removal from air. Chem. Eng. Sci., 124, 118-124 (2015)). The values obtained when testing the exemplary device/module are considerable.

HFM Bore with Microcrystals

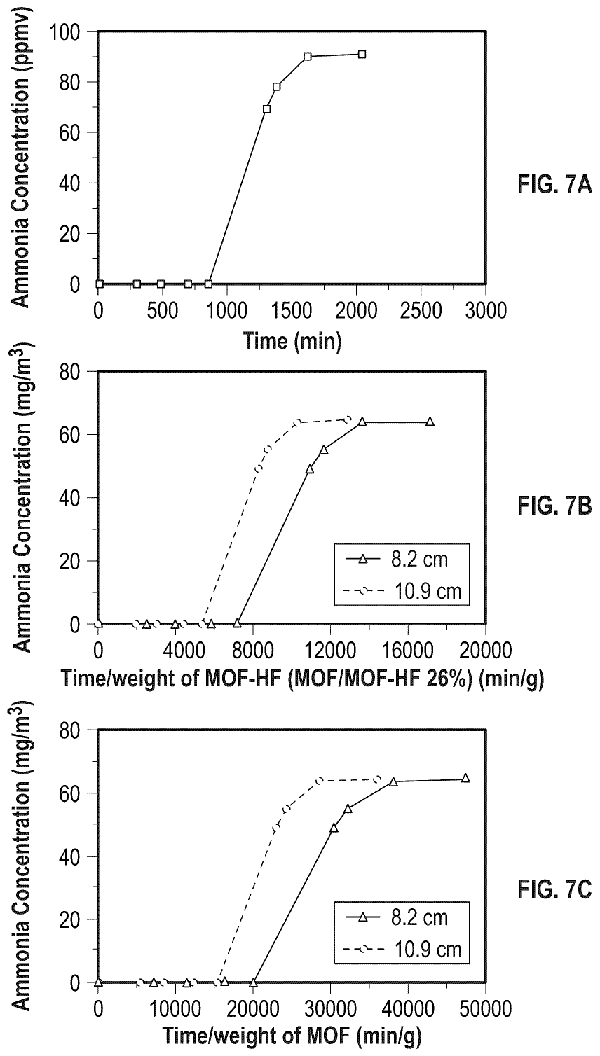

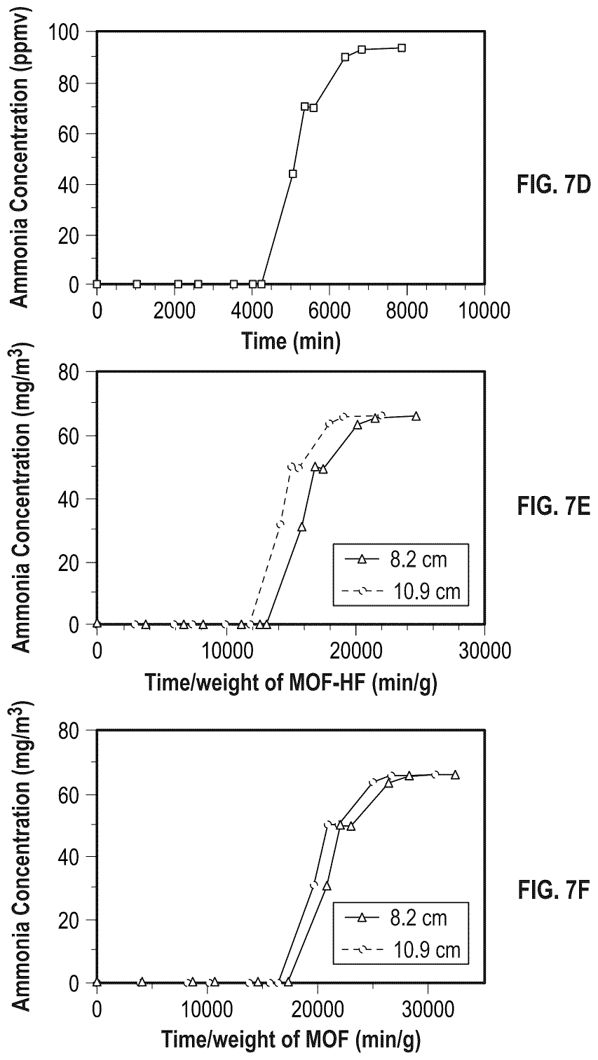

One tested embodiment of the module included a Nylon HFM module with the HFM bore having some microcrystals (e.g., some microcrystals occupying 1-40% inclusive of the volume of the hollow fiber bore). The results are shown in FIGS. 7A-F. FIG. 7A shows that the time when NH₃ first appears at trace levels in the outlet gas stream has been extended to 855 min. This was expected since larger adsorbent amount provided a higher sorption capacity and longer time for initial appearance. On the other hand, a plot was generated in terms of breakthrough time/weight of adsorbent (with and without HFM), the times were longer, indicating that sorption capacity of additional sorbent microparticles in the HFM bore are somewhat higher than that of the nanocrystals in the HFM pores only. The results suggest significant open space in the membrane pores (FIGS. 3A-B). Thus, the MOF microcrystals located in the HF bores extend the contact time of ammonia molecules and MOF particles.

From the solid line in FIG. 7C, the sorption capacity was calculated to be 1.38 mmol/g (conditions for this calculation are similar to that of MOFs in membrane pores only). One reason for this result is that the ammonia concentration in the gas used in the testing was low (compared to a much higher value of ˜1000 ppm ammonia in other studies). An additional reason for this behavior is that the HFM bores were not well packed with MOF microcrystals. No attempt was made to enhance the packing density during experimentation, since the goal was to demonstrate the concept and feasibility. However, the MOF loading in HFM bores increased the contact time of ammonia to the adsorbent UiO-66-NH₂ MOF.

FIGS. 7D-F illustrate the adsorption behavior when the MOFs were located in hollow fiber membrane pores, the HFM bores, and in the extra capillary space. FIG. 7D shows the overall adsorption behavior in terms of outlet ammonia concentration vs. time, with trace level ammonia showing up at around 4000 min. FIGS. 7E-F show the adsorption behavior as outlet ammonia concentration vs. time/weight of MOF crystals, plus HFM and time/weight of MOF crystals only based on the whole length and active length of the HFMs, respectively. Between FIGS. 7C and 7F, the time/weight of MOF approaches a high value of 20000 min/g of MOF.

BET and PXRD Results.

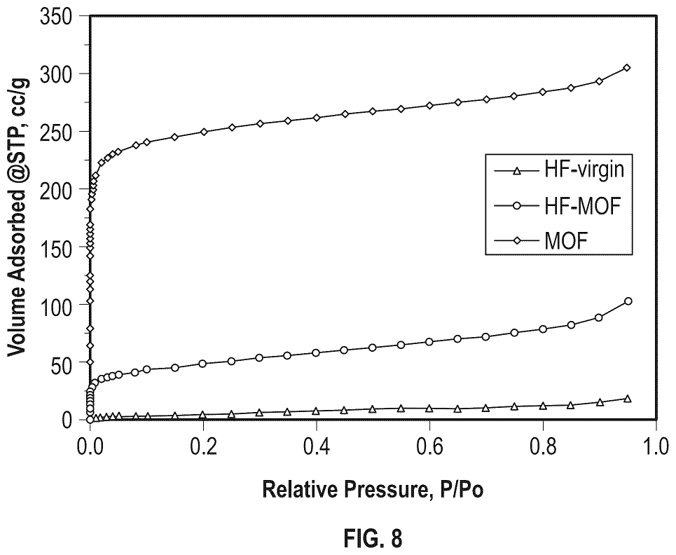

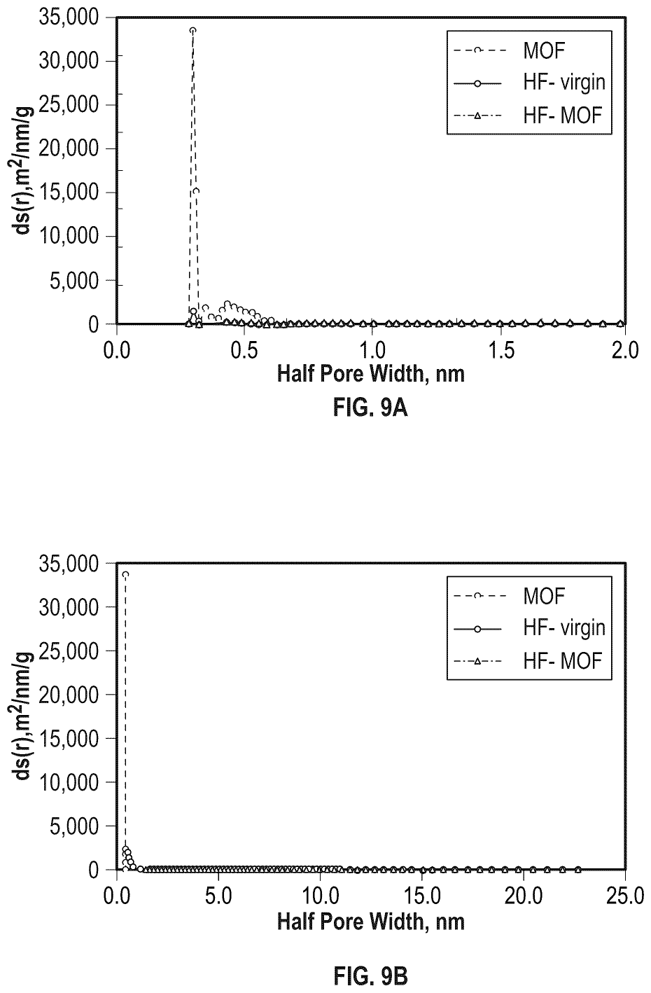

The N₂ adsorption and desorption isotherms are shown in FIG. 8 for virgin Nylon 6 HFM, Nylon 6 HFM with UiO-66-NH₂ MOF loading, and UiO-66-NH₂ MOF achieved during HF-MOF preparation. The y-axis unit of cm³/g refers to per gram of sample. The sharp rise in the adsorbed volume in the plot at very low P/Po represents the narrow micropores (<˜1 nm) grown without membrane. Using Density Functional Theory (DFT) characterization methods, the pore size distributions determined from N₂ isotherms is shown in FIGS. 9A-B. The void size diameter for most of the synthesized MOF is 0.6 nm, which is consistent with the dimension of UiO-66 MOF reported previously. (See, e.g., Cavka, J. H., et al., A new zirconium inorganic building brick forming metal organic frameworks with exceptional stability. J. Am. Chem. Soc., 130 (42), 13850-13851 (2008)). The approximately sharp turn and subsequent slow increase implies narrow mesopores (<˜2.5 nm) and macropores. The table of FIG. 22 lists the corresponding BET surface areas. Pore size distributions were determined from N₂ isotherms by BET multiple-point analysis.

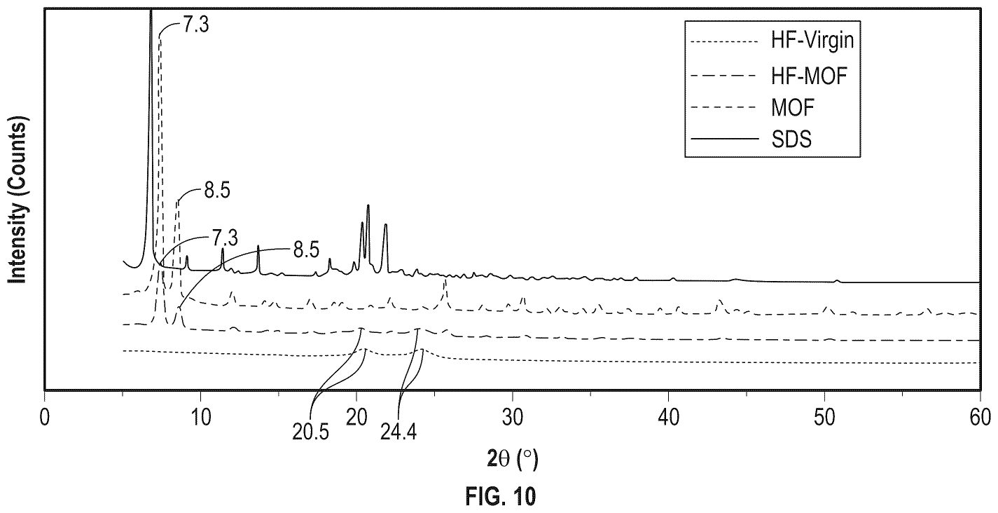

FIG. 10 provides the PXRD patterns of the virgin Nylon 6 hollow fiber membrane (HF-Virgin), UiO-66-NH₂ MOF synthesized in Nylon 6 hollow fiber membrane (HF-MOF), and UiO-66-NH₂ MOF (MOF) achieved during synthesis. PXRD patterns of the sodium dodecyl sulfate (SDS) are also included. These results demonstrate that the PXRD patterns of UiO-66-NH₂ MOFs synthesized are identical to the known PXRD patterns for this MOF; the two highest diffraction peaks at 20=7.3° and 8.5° correspond to its d-spacing of 12.1 Å and 10.5 Å. The PXRD patterns of HF-MOF contain the prominent peaks of MOF and HF-virgin; the main peaks of reactants ZrCl₄, H₂BDC-NH₂ and SDS are not shown since these are identical to those reported previously. (See, e.g., Song, Y., et al., Membrane-supported metal organic framework based nanopacked bed for protection against toxic vapors. Separation and Purification Technology, 251, 117406 (2020)).

Direct utilization of the extraordinary sorption capabilities of microcrystals and nanocrystals of the UiO-66-NH₂ MOF in a high surface area adsorber has been achieved by solvothermal synthesis of the MOFs inside and outside the pores of porous hydrophilic Nylon HFMs packed in a cylindrical module. No special steps were needed to achieve this, unlike other studies, since the organic synthesis solution for the MOF spontaneously wetted the pores of Nylon HFMs. (See, e.g., Song, Y., et al., Membrane-supported metal organic framework based nanopacked bed for protection against toxic vapors. Separation and Purification Technology, 251, 117406 (2020); Song, Y., et al., Graphene oxide and metal organic framework based breathable barrier membrane for toxic vapors, ACS Appl. Mater. Interfaces, 14, 31321-31331 (2022)). This technique can be adopted for any kind of MOF synthesis as long as the HFMs are chemically and thermally compatible with the MOF synthesis environment.

The issue of pore wetting by the synthesis liquid mixture is considered as well. If the pores are not spontaneously wetted, then pressure induced pore wetting can be implemented. For such cases, it would be desirable to carry out the synthesis using a potted HFM module such that pore wetting pressure can be applied.

One of the novel features of the process is MOF utilization in a nanopacked bed. MOFs obtained after synthesis as loose powders need to be processed into various shapes, e.g., granules, pellets, or the like, or synthesized in situ. Processing loose MOF powders into various shapes via densification can lead to a loss of as much as 50% of the BET surface area. In contrast, the exemplary device/module has the alternate arrangement of synthesizing in situ in the pores of the hollow fiber membrane and in the bore and outside, and subsequently the device is ready to go after MOF synthesis. The issue of mechanical strength does not arise for crystals in the pores of the hollow fiber membrane. Microcrystals in the bore of the hollow fibers or in the extra capillary space do not have any demanding strength requirement. In conventional processes, the MOF is first synthesized, filtered, dried, and subjected to considerable pressure separately for pelletization. The pellets are then used in columns. This whole process can be implemented in one device, i.e., the exemplary device in the form of the porous hollow fiber membrane module, where the MOF synthesis takes place and the device is ready for use once drying is done.

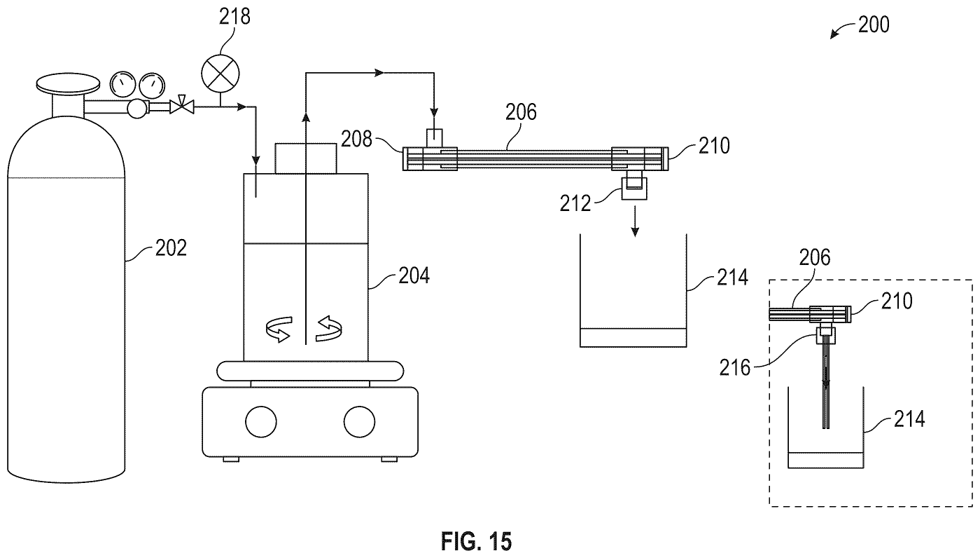

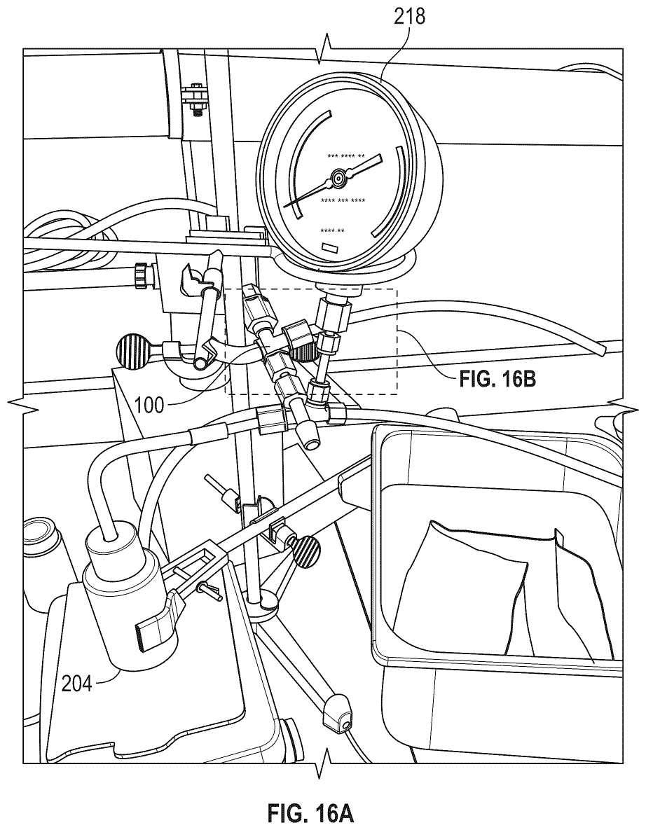

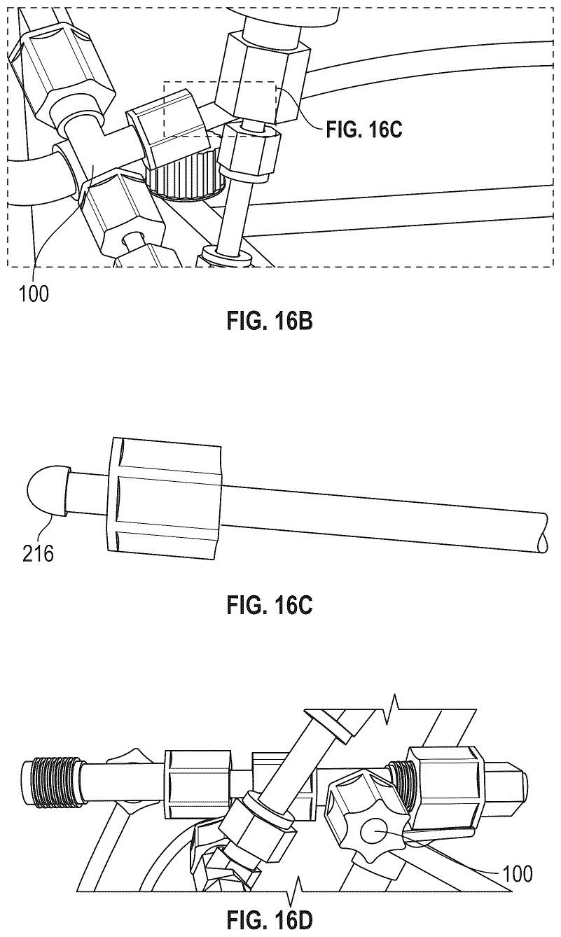

If two different MOFs are needed for efficient adsorption of two different gases/vapors, such hollow fiber modules may be used. (See, e.g., Wang, Q., et al., One-step removal of alkynes and propadiene from cracking gases using a multi-functional molecular separator. Nature Communications, 13:2955 (2022)). As such, in some embodiments, the module can include two different types of MOFs. However, the MOF incorporation methods is varied slightly in such embodiments. For example, one MOF can first be incorporated in the pores via synthesis. Subsequently, the extra capillary space and the HFM bores can be washed free of the synthesized MOF, and then a suspension of MOF nanocrystals and microcrystals of the second MOF can be brought in from the shell side and tube-side, with the particular MOF incorporated into the module by removing the solvent/carrier liquid via filtration by blocking the module exits for the MOF particles (as shown in FIG. 15). In particular, FIGS. 15 and 16A-C are views of the setup 200 for packing MOF particles into the shell side of the MOF HFM modules. The setup 200 includes a cylinder or tank 202 of UHP N₂ fluidly connected to a tank 204 with the MOF suspension, and a pressure gauge 218 in-between. The MOF suspension is fed into a module 206 having opposing blocked ends 208, 210, and the downstream end having an ePTFE membrane 212 and/or cotton 216 at the outlet to a container 214.

As used herein, the “tube side” refers to the space covered by the internal diameter (ID) of the hollow fiber, which is often called the lumen or bore of the hollow fiber. As used herein, the “shell side” refers to the space outside of the hollow fiber outside diameter and is in-between multiple hollow fibers present in a bundle in the device/module. The process can be expanded to three different MOFs by independently using the extra-capillary space for a second MOF and the hollow fiber bore for a third MOF. (See, e.g., Wang, Q., et al., One-step removal of alkynes and propadiene from cracking gases using a multi-functional molecular separator. Nature Communications, 13:2955 (2022)). If regeneration of each MOF can be carried out at a different temperature, three packed beds in the same device each regenerated at a different temperature with shell-side feed of the gas and the product stream withdrawn through the tube-side or vice versa, can be used.

As such, a convenient method is provided for utilizing fragile MOF nanoparticles and microparticles in a compact HFM device for adsorption of gases/vapors via, for example, in situ MOF synthesis. HFM devices are modular and compact and are used in large scale for industrial membrane gas separations. Excellent adsorption performances were demonstrated by adsorbing ammonia from a dilute ammonia-containing gas stream in three configurations: MOF nanocrystals in the HFM pores; MOF microcrystals present in addition in the HFM bore, and MOF microcrystals also present in the shell side of the hollow fibers, and the extra capillary space. Nylon HFMs provide a convenient platform for direct synthesis of MOFs from a demanding solvent-based chemical as well as thermal environment. This eliminates the need for making beads and pellets of MOFs and utilizes the high surface area per unit device volume provided by hollow fiber membranes. The processes of making beads, pellets or the like, using loose MOF powders obtained by hydrothermal/solvothermal synthesis can lead to a considerable loss of BET surface area of MOFs. (See, e.g., Shah, B. B., et al., Mechanical properties of shaped metal-organic frameworks. Topics in Current Chemistry, 377:25 (2019)).

Although the results discussed herein are for adsorption of NH₃ from a gas phase, sorption of suitable adsorbates from a liquid phase has also been carried out successfully in such porous membranes filled with UiO-66-NH₂ MOF nanoparticles and microparticles. This includes situations where the liquid phase wets the membrane pores and the liquid is in direct contact with the MOFs. If the liquid phase does not wet the membrane pores, adsorption or desorption can still go on if the species to be adsorbed or desorbed is volatile or semi-volatile. The device therefore provides versatility in the potential uses.

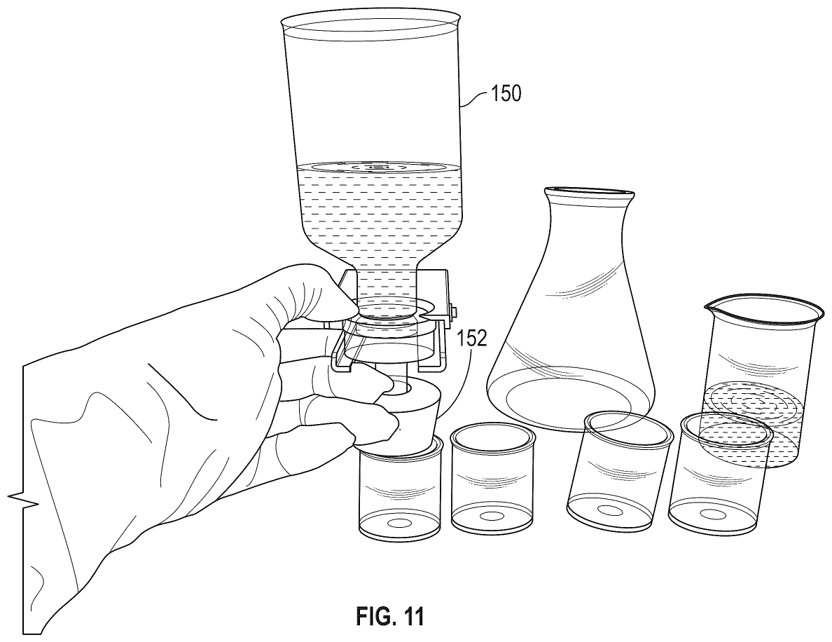

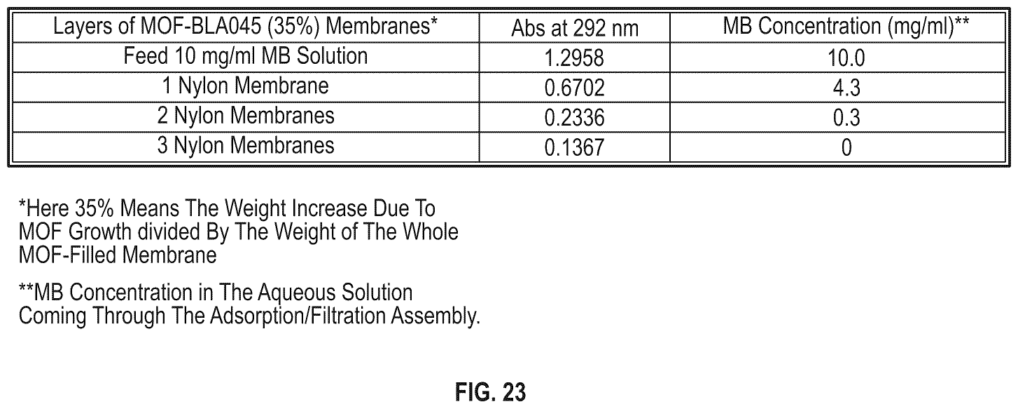

An example is provided herein using a flat porous Nylon membrane for illustration, although a hollow fiber membrane device would provide improved results in terms of providing a much longer packed bed. A flat Nylon membrane (BLA045, pore size: 0.45 μm; alternately BLA020, pore size: 0.20 μm; 3M Corporation) was treated in the MOF synthesis reactor (instead of loose hollow fibers) and ended up with UiO-66-NH₂ MOF nanocrystals and microcrystals incorporated in the membrane pores. Such a membrane was subjected to treatments similar to that for HFMs in terms of drying. Then, this membrane was installed in a Buchner filtration funnel 150, as shown in FIG. 11. The funnel 150 was filled with an aqueous solution of methylene blue (MB) and the solution was allowed to seep through the membrane(s) 152 by gravity. The Nylon membrane was spontaneously wetted by water. Experiments were done with either a single Nylon membrane or two Nylon membranes, one on top of the other, or three such Nylon membranes on top of one another. The results are provided in the table of FIG. 23 in terms of UV-vis absorption results. The results show that as the depth of the MOF layer in membrane pores increased by stacking two or three membranes on top of each other, ultimately all of the MB was adsorbed with three stacked flat membranes.

Methods

Materials and chemicals used for experimentation include: Nylon 6 (polyamide PA6) hollow fiber membranes (hydrophilic; pore size: 0.2 μm, porosity: 75%, OD: 1,000 μm; ID: 600 μm; Enka America Inc., Asheville, NC); and Methanol (EMD Millipore, ≥99.8%), DMF (Fisher Chemical, 99.9%), zirconium (IV) chloride (Alfa Aesar™, >99.5%), 2-aminoterephthalic acid (H₂BDC-NH₂, Acros Organics™, 99%) were used for UiO-66-NH₂ MOF synthesis.

MOF synthesis in Nylon 6 HFMs and preparation of MOF-loaded Nylon HFM-based modules: This synthesis can be carried out in at least two ways. In some embodiments, using loose hollow fiber membranes, one can carry out MOF synthesis under appropriate solvothermal/hydrothermal synthesis conditions (identified in the next paragraph). In some embodiments, one can take a hollow fiber membrane module with hollow fibers potted into a tube-sheet at both ends, fill the internal volume in the module with the synthesis solution, and carry out the synthesis. The procedure employed with the first approach is described below. All membrane modules used were built with such loose HFMs, which underwent the solvothermal synthesis in a demanding solvent environment.

Loose Nylon hollow fiber membranes were inserted, wetted and submerged in mixed reactant-containing solution placed in a Teflon-lined pressure vessel. The solution was prepared by dissolving 70 mmol NH₂H₂BDC (2-aminoterephthalic acid) in 140 g DME and mixing it with 70 mmol ZrCl₄ dissolved in 35 g methanol along with 5 mmol/L of sodium dodecyl sulfate (SDS). The solution was sonicated for 15 min by an ultrasonic processor (Cole Panner, Vernon Hills, IL). Before closing the lid of the vessel, the vessel was purged with high purity N₂ to remove air. The vessel was put into an oven at 120° C. for 18 hr. After the treatment, the HFMs were washed with methanol. For the MOF-filled HFMs used in module Type I, methanol was pushed into the tube side of the hollow fibers to remove the MOF crystals synthesized in the bore of the HEMs. For the MOF-filled HFMs used in module Type II, the hollow fibers were rinsed with methanol to clean the outside of the MOF-filled HF without pushing methanol into the tube side to remove MOF crystals from the HFM bore. The MOF-filled Nylon HFMs were next dried at 60° C. for 2 weeks in a vacuum drying oven (Zenith Lab Inc., Brea, CA). After sealing the MOF-HFMs into the module (procedure described below), the MOF-HFM module was kept dry in a desiccator connected to fume hood vacuum at 50° C. for 10 days.

To prepare the MOF-filled Nylon hollow fiber membrane module (shown in FIG. 1), five MOF-filled HFMs were potted in the module shell (Teflon® FEP semi-clear tubing, ⅛″ ID, ¼″ OD) by epoxy adhesive (Loctite EA M-21HP™). The total length of each HFM in the module was 10.9 cm. About 1.35 cm length of the hollow fibers at each end were potted with an epoxy adhesive. The active length of the hollow fiber was 8.2 cm (see FIG. 1A and FIG. 12). For each hollow fiber, the surface areas based on virgin Nylon HF ID and OD were: outer surface area of 3.142 mm×8.2 cm=2.576 cm 2; inner surface area of 1.729 mm×8.2 cm=1.418 cm². For five HFMs in the module, the total outer surface area was 12.88 cm² for a total inner surface area of 7.09 cm 2.

For preparation of the Type III MOF-HFM module where MOFs are located in hollow fiber membrane pores, the HFM bores, and the extra capillary space, 5 g of the UiO-66-NH₂ MOF, obtained during the preparation of Type I and Type II MOF-filled HFMs, were added into 100 ml methanol to prepare a MOF suspension. A magnetic stirrer was used to prepare the MOF suspension and maintain the stability of the suspension. The MOF microcrystals and nanocrystals were introduced into the shell side of the Type II MOF-HFM module by pushing the MOF suspension into the module by N₂ gas (pressure 1-2 psig) and blocking the expulsion of MOF microparticles and nanoparticles by an ePTFE membrane (GMM 404 membrane; pore size: 0.45 μm) and cotton sliver.

FIG. 15 and FIGS. 16A-D show the setup for introducing the MOF nanocrystals into the shell side of the MOF-HFM module. The module was dried at 50° C. under vacuum for 3 days. The increase in weight due to the MOF nanocrystals filled in the shell side was 0.2 g. MOF loading percent in the shells side was about 50%. Subsequently, one side of the tube side was sealed by epoxy as shown in FIG. 1A. FIGS. 17A-C shows the completed Type III MOF-HFM module.

A second approach to synthesis is described herein. In particular, MOF synthesis in Nylon 6 HFMs, their bore and outside of the HFMs in preexisting Nylon HFM-based modules can be performed with this procedure. This synthesis procedure can be identical to that described above, except instead of loose HFMs, a preformed HFM module filled with the mixed reactant-containing solution is placed inside the Teflon lined reactor with all module ends open in a closed reactor. After the reaction is over and the module is cooled, the module is drained of the remaining solution by N₂ pressure. If another synthesis step is needed to increase the MOF level in the pores, the entire step can be repeated. After draining, the module is be subjected to vacuum and/or low level heating with heated N₂ gas stream to desorb the solvents.

Characterization of MOF-filled Nylon 6 hollow fiber membrane: Empyrean multipurpose powder X-ray diffractometer (PXRD) with PIXcell^{ID} detector (Serial 202627, PANalytical) was used to obtain the powder X-Ray diffraction patterns of virgin Nylon 6 HFM and MOF-filled HFM. PXRD patterns of all samples were scanned by Cu K(alpha) radiation (λ=1.54 Å, 40 mA, 45 kV) from 5° to 60° of 2θ, step size=0.0260° (2θ), scan step time=99.176 s. Fourier-transform infrared spectroscopy (FTIR) was carried out in an Agilent Cary 670 FTIR spectrometer for FTIR spectra of samples. 32 scans were taken per sample over 6000-400 cm⁻¹ with a resolution of 4 cm⁻¹.

Scanning electron microscopy (SEM) was implemented using a separate field emission-scanning electron microscopes (FE-SEM, Model LEO1530vp) to obtain the membrane cross sectional images. The samples were mounted on the SEM stubs by carbon tape and coated with 10 nm of gold by Turbomolecular pumped coater (Model EMS Q150T ES).

N₂ isotherm curves of samples were collected by an automated gas sorption analyzer (Model #: ASIQM000000-6, Quantachrome Instruments, Boynton Beach, FL). Pore size distribution and Brunauer-Emmett-Teller (BET) surface area were calculated by commercial DFT software combined with the instrument operation interface. Before starting BET measurement, membrane samples were degassed at 70° C. for 48 hr and UiO-66-NH₂ MOF samples were degassed at 120° C. for 18 hr.

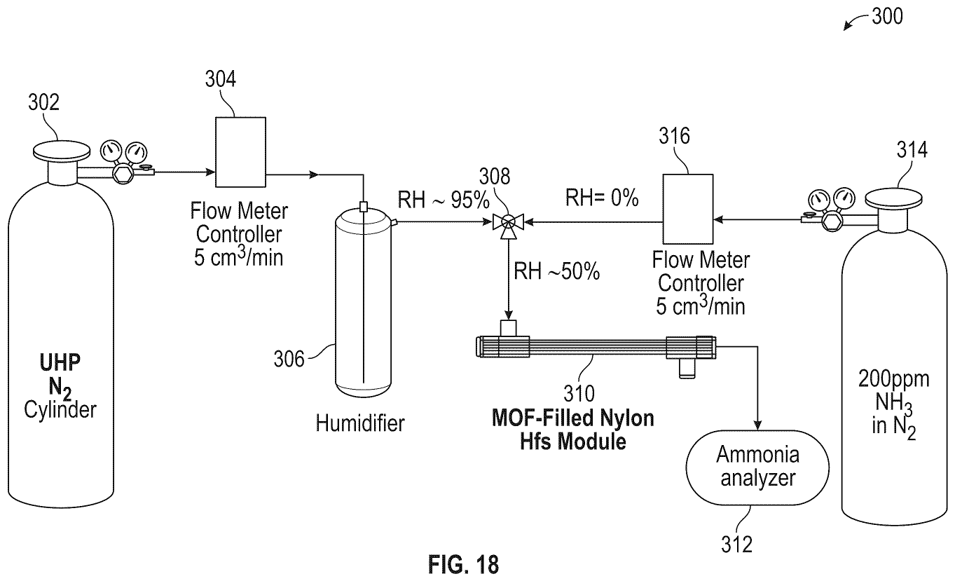

Ammonia breakthrough experiment: The dead-end setup 300 for the breakthrough testing using ammonia-sensing chips in the flow-through mode is shown in FIG. 18. The setup 300 included a cylinder 302 with UHP N₂, a flow meter controller 304 (5 cm³/min) upstream of the cylinder 302, a humidifier 306 upstream of the controller 304, and a three-way valve 308 upstream of the humidifier 306. The setup 300 included the MOF-filled Nylon HFs module 310 in fluid communication with the valve 308, and an ammonia analyzer 312 downstream of the module 310. The setup 300 included a cylinder 314 with 200 ppm of NH₃ in N₂, and a flow meter controller 316 (5 cm³/min) upstream of the cylinder 314 and in fluid communication with the valve 308. A stream of 200 ppmv ammonia in N₂ calibration gas (Casco, Oldsmar, FL) was mixed with wet (relative humidity, RH=˜95%) N₂ gas before introduction of the mixed gases into the membrane module 310. The flow rates of these two streams were adjusted to 5 cm³/min respectively by two mass flow rate controllers 304, 316 (Model 8272-0453 and 829-C4212T, Matheson-Trigas, Montgomeryville, PA). The ammonia concentration at module outlet was obtained by a CMS analyzer 312 (Draeger, Telford, PA) with ammonia. CMS chips (0.2-5 ppm, Model 6406550, 2-50 ppm, Model 6406130, 10-150 ppm, Model 6406020, Draeger, Telford. PA).

Freshly made MOF-filled Nylon HFs module: The freshly made MOF-filled Nylon HFs were next dried at 60° C. for 2 weeks in a vacuum drying oven (Zenith Brea, CA). After potting MOF-HFs into a module, the freshly made MOF HF-based module was kept in a desiccator connected to the lab hood vacuum at 50° C. for 10 days.

Regeneration of MOF-filled Nylon HF module: The MOF-filled HFs in the module used in the ammonia breakthrough testing described earlier with 100 ppmv wet ammonia calibration gases were regenerated by heating in a vacuum drying oven (Zenith Lab Inc., Brea, CA) at 60° C. for 4 days and heating in a desiccator (connected to hood vacuum) at 50° C. for 4 days. Then, the blocking performances of the regenerated MOF-filled HFs module to ammonia were measured by the same steps as above.

Additional mode of module operation: In another mode of operation of the HFM module filled with microcrystals and nanocrystals of MOFs, the feed gas can enter through port 124, as well as the end port 122 which will not be blocked from passage of fluids and/or gases. The treated gas passes out through exit ports 122, 126. Under such a condition, there is significantly less convective flow of gases through the membrane pores; rather, there is diffusive exchange between the gas stream flowing in the extra capillary space with the nanocrystals in the membrane pore. Similarly, there is diffusive exchange between the gas stream flowing in HFM bore with the MOF nanocrystals in the HFM pores.

Additional Methods

Calculation Method for Estimating Adsorption Capacity

The results from FIG. 6C were used for the breakthrough behavior plotted in terms of time/weight of MOF and the corresponding numerical data as shown in the table of FIG. 21. The detailed calculations are provided, along with the breakthrough in FIGS. 13A-B. The capacity up to the point when ammonia first appears in the outlet at a very low concentration is 0.858 mmol/g. When the complete feed breakthrough concentration is considered, the corresponding sorption capacity is 1.574 mmol/g.

Calculation was based on the active length of the HFM in the module using Equations 1˜4 below.

Weight of MOF crystals(g)=0.0247 g (1)

Take the plateau/maximum NH₃ concentration as:

$$66 mg / {m}^{3} ( = \frac{67 mg / {m}^{3} + 66 mg / {m}^{3}}{2} ) \qquad ( 2 )$$

Amount of NH₃ blocked in the period that is a rectangle with no ammonia at the outlet is represented by:

$$22106 \frac{min}{g} \times 66 \frac{mg}{{m}^{3}} \times 10 \frac{{cm}^{3}}{min} \times \frac{1 mmol {NH}_{3}}{17 mg {NH}_{3}} \approx 0.8 \; 582 mmol \text{/g} \qquad ( 3 )$$

Amount of NH₃ blocked in the period roughly approximated by a triangle when ammonia has started appearing at the outlet at low concentrations before breakthrough is represented by:

$$\frac{1}{2} \times ( 59000 - 22106 ) \frac{min}{g} \times 66 \frac{mg}{{m}^{3}} \times 10 \frac{{cm}^{3}}{min} \times \frac{1 mmol {NH}_{3}}{17 mg {NH}_{3}} \approx 0.7162 \text{mmol/g} \qquad ( 4 )$$

Total amount of NH₃ blocked by the MOF-HFM module≈1.574 mmol/g.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made explicit herein, without departing from the spirit and scope of the invention.

1. A module for gas and/or vapor removal from a fluid stream, the module comprising:
at least one hollow fiber membrane including a first end and an opposing second end, the at least one hollow fiber membrane including a fiber wall defining an interior bore extending from the first end to the opposing second end and defining a passage for fluid flow through the at least one hollow fiber membrane; and
a bed of metal-organic framework (MOF) integrated into membrane pores of the fiber wall of the at least one hollow fiber membrane.

2. The module of claim 1, wherein the interior bore defines a hollow fiber bore.

3. The module of claim 1, wherein the at least one hollow fiber membrane comprises multiple hollow fiber membranes each including the interior bore extending from the first end to the opposing second end of the module.

4. The module of claim 3, wherein each of the interior bores defines the passage for fluid flow through the respective hollow fiber membranes.

5. The module of claim 3, comprising an extracapillary space between outer walls of the multiple hollow fiber membranes.

6. The module of claim 1, wherein the fiber wall defines a porous structure including the membrane pores.

7. The module of claim 5, wherein the bed of MOF comprises microcrystals disposed in the extracapillary space.

8. The module of claim 6, wherein the bed of MOF includes nanocrystals in the membrane pores of the fiber wall.

9. The module of claim 6, wherein the bed of MOF includes nanocrystals in the membrane pores of the fiber wall and microcrystals in the interior bore.

10. The module of claim 5, wherein the bed of MOF includes nanocrystals in the membrane pores, a first set of microcrystals in the interior bore, and second set of microcrystals in the extracapillary space.

11. A system for gas and/or vapor removal from a fluid stream, comprising:
a module including:
(i) at least one hollow fiber membrane including a first end and an opposing second end, the at least one hollow fiber membrane including a fiber wall defining an interior bore extending from the first end to the opposing second end and defining a passage for fluid flow through the at least one hollow fiber membrane, and
(ii) a bed of metal-organic framework (MOF) integrated into membrane pores of the fiber wall of the at least one hollow fiber membrane;
a first port assembly coupled to the first end of the at least one hollow fiber membrane; and
a second port assembly coupled to the opposing second end of the at least one hollow fiber membrane.

12. The system of claim 11, wherein the first port assembly includes an inlet port oriented perpendicularly to a central longitudinal axis of the at least one hollow fiber membrane, the inlet port configured to introduce the fluid stream into the interior bore of the at least one hollow fiber membrane through the membrane pores of the fiber wall.

13. The system of claim 12, wherein the first port assembly includes an end port oriented in-line with the central longitudinal axis of the at least one hollow fiber membrane, wherein (i) the end port is blocked to prevent passage of the fluid stream through the end port, or (ii) the end port is open to allow passage of the fluid stream through the end port.

14. The system of claim 11, wherein the second port assembly includes an outlet port oriented in-line with a central longitudinal axis of the at least one hollow fiber membrane, the outlet port configured for exit of the fluid stream from the interior bore of the at least one hollow fiber membrane.

15. The system of claim 14, wherein the second port assembly includes an end port oriented perpendicularly to the central longitudinal axis of the at least one hollow fiber membrane, wherein (i) the end port is blocked to prevent passage of the fluid stream through the end port, or (ii) the end port is open to allow passage of the fluid stream through the end port.

16. A method for gas, vapor and/or liquid adsorption, comprising:
providing a module including (i) at least one hollow fiber membrane including a first end and an opposing second end, the at least one hollow fiber membrane including a fiber wall defining an interior bore extending from the first end to the opposing second end and defining a passage for fluid flow through the at least one hollow fiber membrane, and
synthesizing a first bed of metal-organic framework (MOF) directly inside membrane pores of the fiber wall of the at least one hollow fiber membrane.

17. The method of claim 16, wherein the membrane pores include submicron pores and bores of the order of about 100-3000 micrometers, inclusive.

18. The method of claim 16, comprising synthesizing a second bed of metal organic framework (MOF) directly inside the membrane bores of the at least one hollow fiber membrane.

19. The method of claim 18, wherein the at least one hollow fiber membrane comprises multiple hollow fiber membranes and the module includes an extracapillary space between outer walls of the multiple hollow membranes, and the method comprises synthesizing a third bed of metal organic framework (MOF) directly inside the extracapillary space.

20. The method of claim 16, wherein the first bed of MOF is integrated into the membrane pores.
